(19) United States
(12) Patent Application Publication
(10) Pub. No.: US 2014/0006709 A1
(43) Pub. Date: Jan. 2, 2014

(54) RELAY DEVICE AND RELAY METHOD

(71) Applicant: FUJITSU LIMITED, Kawasaki-shi (JP)

(72) Inventor: Takashi Kawada, Yokohama (JP)

(73) Assignee: FUJITSU LIMITED, Kawasaki-shi (JP)

(21) Appl. No.: 13/848,780

(22) Filed: Mar. 22, 2013

(30) Foreign Application Priority Data
Jun. 29, 2012 (JP) 2012-146883

(51) Int. Cl. G06F 3/06

(52) U.S. Cl. CPC G06F 3/0689
USPC 711/114

(57) ABSTRACT

A processor receives part data of data group from a transmission source. The processor stores the received part data in a first storage region of a first storage unit in accordance with storing order when there is a free region in the first storage region. The processor stores the received part data in a second storage region of the first storage unit when there is no free region in the first storage region. The processor evacuates the part data stored in the second storage region to a second storage unit in accordance with the storing order. The processor deletes the evacuated part data from the second storage region. The processor restores, when some part data remains in the second storage unit and a free region has been generated in the first storage region, the remaining part data to the generated free region in accordance with the storing order.

### CROSS-REFERENCE TO RELATED APPLICATION

This application is based upon and claims the benefit of priority of the prior Japanese Patent Application No. 2012-146883 filed on Jun. 29, 2012, the entire contents of which are incorporated herein by reference.

### FIELD

The embodiment discussed herein is related to a relay device and a relay method.

### BACKGROUND

There have been redundant arrays of inexpensive disks (RAID) devices which employ a distributed cache memory type storage system. The RAID devices may perform, in order to improve reliability, remote copying of which the storing order is guaranteed so as to perform mirroring of data within the own device serving as a transmission source to another RAID device.

Remote copying is to copy data between computers which are connected to each other by a network or the like. Mirroring is to save, in the event of saving data in a certain storage region, replication of the data to be saved, in another storage region as well.

Also, a RAID device to which data stored in a transmission source has been subjected to mirroring may operate as a relay device, and further perform mirroring of the data to another RAID device serving as a transmission destination. Thus, the data stored in the RAID device serving as the transmission source is subjected to mirroring to multiple RAID devices.

There is a technique as related art in which when data transmitted from a device serving as a transmission source is temporarily stored in a buffer and when storing of the data has ended, the data stored in the buffer is output in batch fashion to a storage unit, and also, the data is transmitted to a device serving as a transmission destination, which is connected to the device serving as the transmission source via a network.

Also, there is a technique in which the usage state of a writing buffer where writing data is temporarily stored is monitored, and when free space of the buffer decreases, information stored in the buffer is evacuated to a separately-provided high-speed disk system. When the usage state improves, the evacuated data is restored to the buffer.

International Publication Pamphlet No. WO2008/139545 and Japanese Laid-open Patent Publication No. 2006-268420 disclose related techniques.

However, the band of a line which connects a transmission source and a relay device may be larger than the band of a line which connects the relay device and a transmission destination. In this case, in the relay device, the amount of the data to be stored in a buffer by reception of data may be greater than the amount of the data to be deleted from the buffer by transmission completion of data. Therefore, with the above-mentioned related art, a free region of the buffer is depleted, which may hinder the relay device from receiving data. Consequently, the transmission source stops transmission of data until a free region is secured in the buffer of the relay device regardless of the state of the line which connects the transmission source and the relay device, and accordingly, transmission efficiency is deteriorated.

With the above-mentioned related art, in the event of evacuating data stored in the buffer to an evacuation disk to secure a free region in the buffer, the transmission source does not have to stop transmission of the data. However, in the relay device, at the time of evacuation or restoration of data, storing order of data stored in the buffer may not be guaranteed. For example, the relay device may transfer, after evacuating preceding data and before restoring the preceding data to transfer the restored preceding data to the transmission destination, subsequent data to the transmission destination without guaranteeing the storing order. Therefore, the transmission destination receives data of which the storing order is not guaranteed, and executes mirroring in order different from the storing order of data in the transmission source, and consequently fails in mirroring.

### SUMMARY

According to an aspect of the present invention, provided is a relay device for transmitting a data group received from a transmission source to a transmission destination. The relay device includes a first storage unit, a second storage unit, and a processor. The first storage unit includes a first storage region and a second storage region. The processor receives part data of the data group from the transmission source. The processor stores the received part data in the first storage region in accordance with storing order when there is a free region in the first storage region. The processor stores the received part data in the second storage region when there is no free region in the first storage region. The processor evacuates the part data stored in the second storage region to the second storage unit in accordance with the storing order. The processor deletes the evacuated part data from the second storage region. The processor transmits the part data stored in the first storage region to the transmission destination. The processor deletes the transmitted part data from the first storage region to generate a free region in the first storage region. The processor determines whether any part data remains in the second storage unit. The processor determines whether a free region has been generated in the first storage region. The processor restores, when it is determined that some part data remains in the second storage unit and that a free region has been generated in the first storage region, the remaining part data to the generated free region in accordance with the storing order. The processor deletes the restored part data from the second storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A to 1C are explanatory diagrams illustrating a flow of mirroring in a storage system;

FIG. 2 is a block diagram illustrating a hardware configuration example of a computer;

FIG. 3 is an explanatory diagram illustrating contents of a buffer realized with a memory;

FIG. 4 is an explanatory diagram illustrating an example of storage contents of a copy session management information table;

FIG. 5 is an explanatory diagram illustrating an example of storage contents of a buffer management information table;

FIG. 6 is an explanatory diagram illustrating an example of storage contents of a device management information table;

FIG. 7 is an explanatory diagram illustrating an example of storage contents of a buffer control management information table;

FIG. 8 is a block diagram illustrating a functional configuration example of a relay device;

FIG. 9 is an explanatory diagram illustrating an example of data transfer;

FIG. 10 is an explanatory diagram illustrating an example of data transfer;

FIG. 11 is an explanatory diagram illustrating an example of data transfer;

FIG. 12 is an explanatory diagram illustrating an example of data transfer;

FIG. 13 is an explanatory diagram illustrating an example of data transfer;

FIG. 14 is an explanatory diagram illustrating an example of data transfer;

FIG. 15 is an explanatory diagram illustrating an example of data transfer;

FIG. 16 is an explanatory diagram illustrating an example of data transfer;

FIG. 17 is an explanatory diagram illustrating an example of data transfer;

FIG. 18 is an explanatory diagram illustrating an example of data transfer;

FIG. 19 is an explanatory diagram illustrating an example of data transfer;

FIG. 20 is an explanatory diagram illustrating an example of data transfer;

FIG. 21 is an explanatory diagram illustrating an example of data transfer;

FIG. 22 is an explanatory diagram illustrating an example of data transfer;

FIG. 23 is a flowchart illustrating a processing procedure of data input processing by a transmission device;

FIG. 24 is a flowchart illustrating a detailed processing procedure of data storing processing;

FIG. 25 is a flowchart illustrating a detailed processing procedure of data transmission processing by a transmission device;

FIG. 26 is a flowchart illustrating a detailed processing procedure of data transmission execution processing;

FIG. 27 is a flowchart illustrating a detailed processing procedure of data transfer processing by a relay device;

FIG. 28 is a flowchart illustrating a detailed processing procedure of data storing execution processing;

FIG. 29 is a flowchart illustrating a detailed processing procedure of data restoration processing; and

FIG. 30 is a flowchart illustrating a detailed processing procedure of data reception processing by a reception device.

### DESCRIPTION OF EMBODIMENT

Hereinafter, an embodiment of a relay device and a relay method will be described in detail with reference to the drawings. The relay device is a computer which transfers data received from a transmission source to a transmission destination while guaranteeing storing order (while guaranteeing sequentiality). Here, when the used amount of a transfer buffer which stores data to be transferred exceeds a threshold, the relay device evacuates data of an amount exceeding the threshold to an evacuation disk. Also, when the used amount of the transfer buffer is less than the threshold, in the event that there is data stored in the evacuation disk, the relay device restores the data stored in the evacuation disk to the transfer buffer.

Thus, the relay device may hold the used amount of the transfer buffer below the threshold, and secure a free region in the transfer buffer. Since free region is secured in the transfer buffer of the relay device, the transmission source may execute transmission of data to the relay device regardless of the transmission state of the relay device. Furthermore, since a free region of the transfer buffer may be secured without increasing the size of the transfer buffer of the relay device and the physical size of memory realizing the transfer buffer of the relay device does not have to be increased, increase in memory manufacturing cost and running cost may be suppressed.

Flow of Mirroring in Storage System

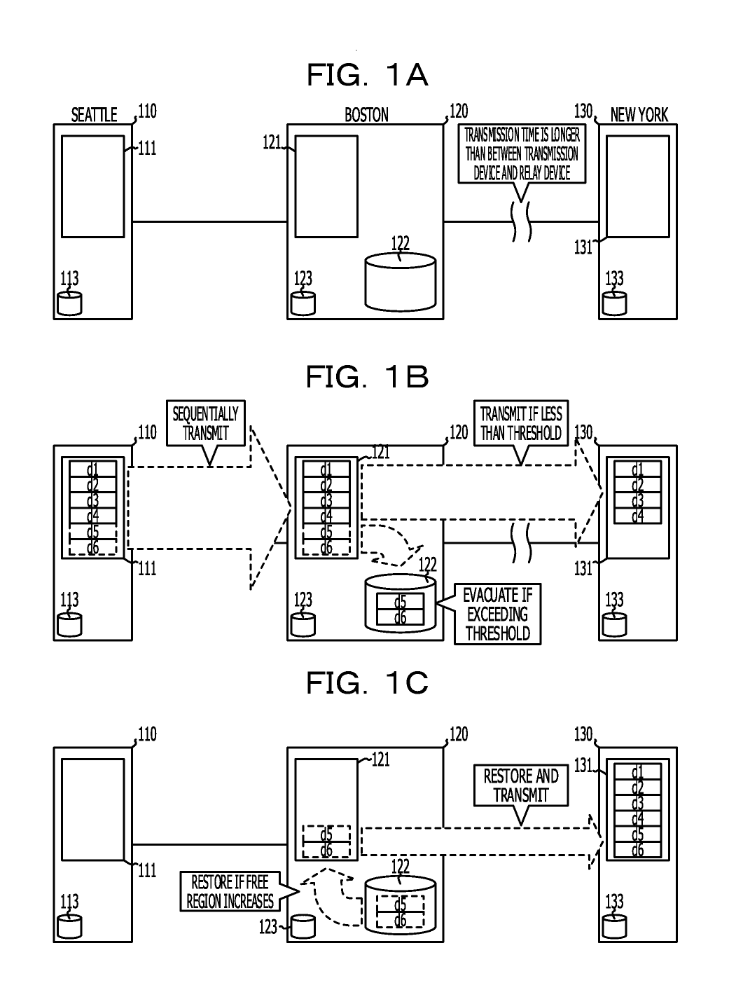

Now, a flow of mirroring in a storage system will be described with reference to FIGS. 1A to 1C.

FIGS. 1A to 1C are explanatory diagrams illustrating a flow of mirroring in a storage system. FIG. 1A illustrates the storage system, FIG. 1B illustrates the contents of data evacuation by a relay device 120 within the storage system, and FIG. 1C illustrates the contents of data restoration by the relay device 120 within the storage system.

In FIG. 1A, the storage system includes a transmission device 110, the relay device 120, and a reception device 130. Here, the transmission device 110 and relay device 120 are connected to each other by a network or dedicated line. Also, the relay device 120 and reception device 130 are connected to each other by a network or dedicated line. In other words, the transmission device 110, relay device 120, and reception device 130 are connected in cascade arrangement.

The transmission device 110 is a computer including a volume 113 for storing data for which Write I/O (input/output) instruction has been accepted from a host device, and a transmission buffer 111 for storing data to be transmitted to the relay device 120. The transmission device 110 accepts Write I/O instruction from the host device, and writes data for which the Write I/O instruction has been accepted in the volume 113.

Also, the transmission device 110 stores data for which Write I/O instruction has been accepted in the transmission buffer 111. The transmission device 110 collectively transmits data within fixed amount stored in the transmission buffer 111 to the relay device 120. Here, the transmission device 110 and relay device 120 make storing order of data agree between the transmission device 110 and relay device 120 by transmitting data after correlating regions of the transmission buffer 111 and a transfer buffer 121 of the relay device 120 by negotiation. The negotiation mentioned here is related art, and accordingly, description thereof will be omitted.

The relay device 120 is a computer including the transfer buffer 121 which stores data received from the transmission device 110 and transmitted to the reception device 130, and an evacuation disk 122 serving as an evacuation destination for data stored in the transfer buffer 121. The relay device 120 stores the data received from the transmission device 110 in the transfer buffer 121, and transmits the data stored in the transfer buffer 121 to the reception device 130. The relay device 120 starts evacuation of the data stored in the transfer buffer 121 to the evacuation disk 122 when the usage amount of the transfer buffer 121 exceeds a threshold.

The relay device 120 restores, when data remains in the evacuation disk 122 and when a free region is generated in the transfer buffer 121, the data stored in the evacuation disk 122 to the free region of the transfer buffer 121, and transmits the restored data to the reception device 130. Here, the relay device 120 and reception device 130 make storing order of data agree between the relay device 120 and reception device 130 by transmitting data after correlating regions of the transfer buffer 121 and a reception buffer 131 of the reception device 130 by negotiation.

The reception device 130 is a computer including the reception buffer 131 for storing data received from the relay device 120, and a volume 133 for storing data stored in the reception buffer 131. The reception device 130 receives data from the relay device 120, stores the received data in the reception buffer 131, and stores the data stored in the reception buffer 131 in the volume 133.

With an example in FIG. 1A, it is assumed that the transmission device 110 is installed in Seattle, the relay device 120 is installed in Boston, and the reception device 130 is installed in New York. Now, it is assumed that transmission time taken for transmitting data between the relay device 120 and reception device 130 is longer than transmission time taken for transmitting data between the transmission device 110 and relay device 120. Difference in transmission time between the devices is specifically caused due to difference in distance between the devices, difference in line performance between the devices, difference in processing performance of the devices, and so forth, for example. Next, description will be provided with reference to FIG. 1B.

In FIG. 1B, the transmission device 110 sequentially writes, in the volume 113, data d1 to d6 for which Write I/O instruction has been accepted, and also stores the data d1 to d6 in the transmission buffer 111. Each time fixed amount of data is stored in the transmission buffer 111, the transmission device 110 collects the fixed amount of data stored in the transmission buffer 111 and starts transmission of the collected data to the relay device 120.

With an example in FIG. 1B, for simplification of description, it is assumed that each of the data d1 to d6 is fixed amount of data. Therefore, each time each of the data d1 to d6 is stored, transmission of the data to the relay device 120 is started. In the event that each of the data d1 to d6 is data less than fixed amount, data is collected within the fixed amount, and transmission to the relay device 120 is started for each collected data. With the example in FIG. 1B, for simplification of description, the transmission device 110 transmits fixed amount of data one at a time, but the transmission method is not restricted to this. For example, the transmission device 110 may collect a plurality of fixed amount of data to perform multiplexing transmission.

On the other hand, the relay device 120 sequentially receives the data d1 to d6 from the transmission device 110 to store in the transfer buffer 121. Here, as described above, transmission time of data from the relay device 120 to the reception device 130 is longer than transmission time of data from the transmission device 110 to the relay device 120. Therefore, it is assumed that, in the event of having started transmission of the data d1 to the reception device 130, the relay device 120 receives the data d2 to d6 before the transmission of the data d1 is completed.

Here, each time the data d1 to d6 is stored in the transfer buffer 121, the relay device 120 determines whether or not the usage amount of the transfer buffer 121 exceeds a threshold, and when less than the threshold, starts transmission of the stored data to the reception device 130. On the other hand, when the usage amount of the transfer buffer 121 exceeds the threshold, the relay device 120 evacuates the stored data to the evacuation disk 122.

With the example FIG. 1B, it is assumed that the threshold is for four sets worth of fixed amount of data. In the event that the data d1 has been stored in the transfer buffer 121, the usage amount of the transfer buffer 121 is less than the threshold, and accordingly, the relay device 120 starts transmission of the data d1 stored in the transfer buffer 121 to the reception device 130. Similarly, in the event that each of the data d2 to d4 has been stored in the transfer buffer 121, the relay device 120 starts transmission of each data to the reception device 130.

On the other hand, in the event that the data d5 has been stored in the transfer buffer 121, the usage amount of the transfer buffer 121 exceeds the threshold, and accordingly, the relay device 120 stores, in the evacuation disk 122, the data d5 stored in the transfer buffer 121. Similarly, in the event that the data d6 has been stored in the transfer buffer 121, the relay device 120 stores the data d6 in the evacuation disk 122.

Thus, the relay device 120 may secure a free region in the transfer buffer 121 to suppress depletion of a free region of the transfer buffer 121. A free region is secured in the transfer buffer 121 of the relay device 120, and accordingly, the transmission device 110 may continuously transmit data regardless of the transmission state of the relay device 120. Next, description will be provided with reference to FIG. 1C.

In FIG. 1C, it is assumed that the relay device 120 has completed transmission of the data d1 to the reception device 130. When a free region increases in the transfer buffer 121 by transmission of the data d1, the relay device 120 restores the data d5 evacuated in the evacuation disk 122 to the transfer buffer 121. The relay device 120 then starts transmission of the data d5 so as to transmit the data d5 to the reception device 130.

Thus, the relay device 120 may secure a free region in the transfer buffer 121 by maintaining the usage amount of the transfer buffer 121 less than the threshold. Also, the relay device 120 may cause the reception device 130 to store data in the volume 133 in accordance with the storing order to guarantee the storing order of the data.

Here, the transmission device 110 and relay device 120 make the storing order of data between the transmission device 110 and relay device 120 agree by negotiation. Also, the relay device 120 and reception device 130 similarly make the storing order of data between the relay device 120 and reception device 130 agree by negotiation.

However, the transmission device 110 and relay device 120 may make the storing order of data between the transmission device 110 and relay device 120 agree by transmitting data in transmission order agreeing with the storing order. Also, similarly, the relay device 120 and reception device 130 may make the storing order of data between the relay device 120 and reception device 130 agree by transmitting data in transmission order agreeing with the storing order.

Thus, the relay device 120 may cause the reception device 130 to store data in the volume 133 in accordance with reception order agreeing with the storing order to guarantee the storing order of the data.

Here, though the relay device 120 is a device which simply relays data, and is a device which does not perform mirroring of data within the own device, the relay device 120 may store the data stored in the transfer buffer 121 in a volume 123 in the same way as with the reception device 130.

Here, the number of the relay devices 120 is one, but the number is not restricted to this. For example, the number of the relay devices 120 may be more than one. For example, in the event that the number of the relay devices 120 is two, the transmission device 110 is connected to the first relay device 120, and the first relay device 120 is connected to the second relay device 120, and the second relay device 120 is connected to the reception device 130.

Here, the number of the transmission devices 110 is one, but the number is not restricted to this. For example, the number of the transmission devices 110 may be more than one. In this case, the relay device 120 includes multiple transfer buffers 121 for the multiple transmission devices 110, and receives data from each of the transmission devices 110 to transmit the received data to the reception device 130. Here, the number of the reception devices 130 is one, but the number is not restricted to this. For example, the number of the reception devices 130 may be more than one. In this case, the relay device 120 transmits data to each of the multiple reception devices 130.

Here, the host device is connected to the transmission device 110, but the connection destination is not restricted to this. For example, the host device may be connected to at least one of the relay device 120 and reception device 130 other than the transmission device 110.

Here, the transmission device 110, relay device 120, and reception device 130 have a function serving only as the respective devices, but the function is not restricted to this. For example, the relay device 120 may have at least one of a function serving as the transmission device 110 and a function serving as the reception device 130 other than the function serving as the relay device 120.

Here, each of the volume 123, transfer buffer 121, and evacuation disk 122 is realized by a different storage device, but the realizing method is not restricted to this. For example, the volume 123, transfer buffer 121, and evacuation disk 122 may be realized by a different region within the same storage device.

Hardware Configuration Example of Computer

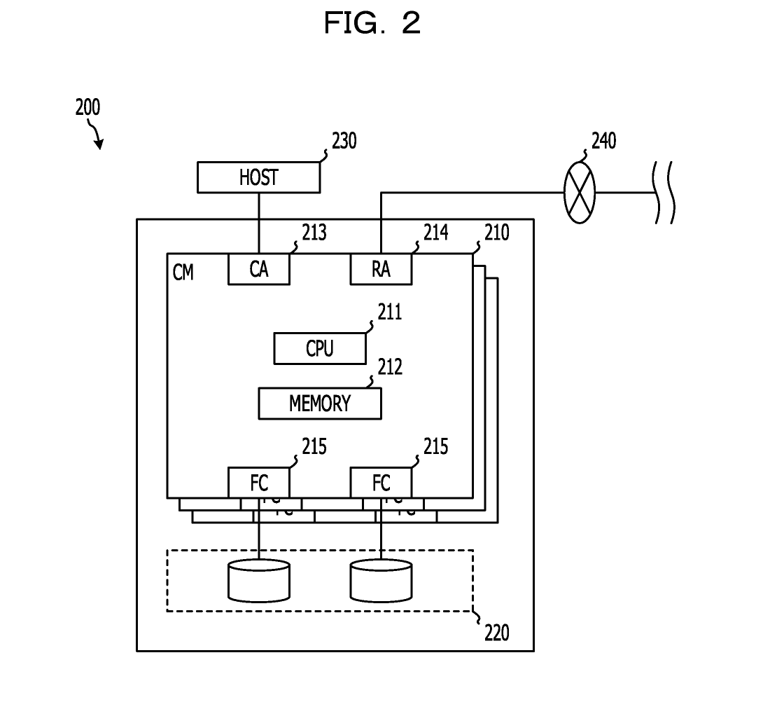

Next, with reference to FIG. 2, description will be made regarding a hardware configuration example of a computer to be used as the relay device 120 according to an embodiment. Also, the computer illustrated in FIG. 2 may be used as the transmission device 110 and reception device 130.

FIG. 2 is a block diagram illustrating a hardware configuration example of the computer. In FIG. 2, a computer 200 is a RAID device including multiple control modules (CMs) 210, and a disk device 220.

The CMs 210 include a central processing unit (CPU) 211, memory 212, a channel adapter (CA) 213, a remote adapter (RA) 214, and fibre channels (FCs) 215.

The CPU 211 executes a program stored in the memory 212 to operate the CMs 210. The memory 212 stores a transfer program and various tables described later. As the various tables, there are provided five tables of a copy session management information table, a buffer management information table, a device management information table, a buffer state management information table, and a buffer control management information table. Also, the memory 212 is used for realization of the transmission buffer 111, transfer buffer 121, or reception buffer 131.

The CA 213 controls interface with the host device 230. The RA 214 controls interface with an external device (for example, transmission device 110 or reception device 130) to be connected to the computer by a network 240 or dedicated line. The FCs 215 control interface with the disk device 220.

The disk device 220 is used for realization of the volume 123 or evacuation disk 122. The disk device 220 includes a single or multiple magnetic devices, for example.

Here, the computer 200 includes the three CMs 210, but the number of the CMs 210 is not restricted to this. For example, the computer 200 may include two or less, or four or more CMs 210. Each of the CMs 210 includes a single CA 213 and a single RA 214, but the number of these is not restricted to this. For example, each of the CMs 210 may include two or more CAs 213, or two or more RAs 214. Each of the CMs 210 includes two FCs 215, but the number of this is not restricted to this. For example, each of the CMs 210 may include three or more FCs 215.

Contents of Buffer

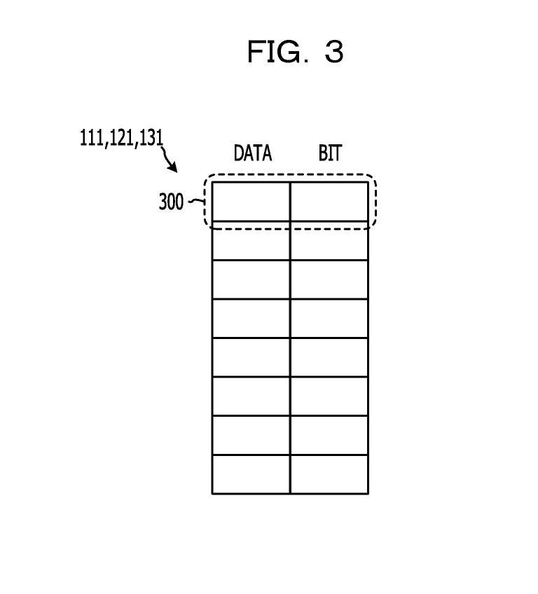

Next, the contents of a buffer realized with the memory 212 will be described with reference to FIG. 3. The buffer is specifically used as the transmission buffer 111, transfer buffer 121, and reception buffer 131, for example.

FIG. 3 is an explanatory diagram illustrating the contents of a buffer realized with the memory 212. The buffer is provided for each of the CMs 210. With the example in FIG. 3, the number of buffers to be provided is one. The buffer is divided into multiple regions having a predetermined size. With the example in FIG. 3, the buffer is divided into eight regions.

Each of the regions includes a data region and a BIT region. The data region is a region where data received from a transmission source, or data to be transmitted to a transmission destination is temporarily stored. The BIT region is a region where BIT information for identifying a storing destination of the data stored in the data region is stored.

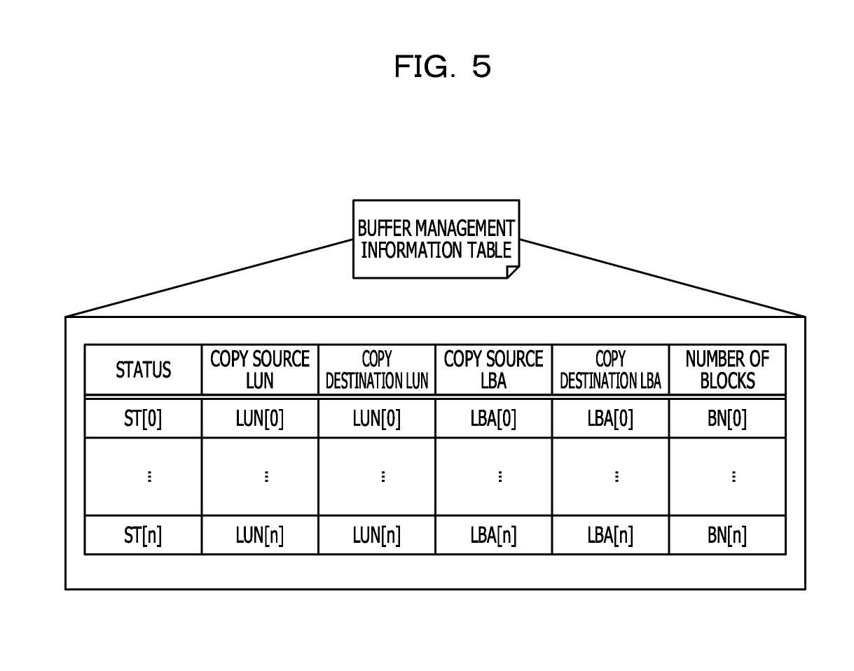

The BIT information includes, for example, a logical unit (LU), a logical block address (LBA), a data size, a copy session number, and so forth. The BIT information is each record of a buffer management information table that will be described later with reference to FIG. 5.

Data and BIT information stored in each region of the buffer are collectively processed. The data and BIT information stored in each region are, for example, collectively transmitted to a transmission destination, collectively evacuated to the evacuation disk 122, or collectively restored from the evacuation disk 122 to the buffer.

Hereinafter, a region of the transfer buffer 121 will be referred to as a buffer-set 300. Also, data and BIT information stored in a buffer-set 300 will collectively be referred to as “buffer-set data”. Here, the number of buffer-sets 300 is eight, but the number is not restricted to this. The number of buffer-sets 300 may be less than eight or more than eight.

Storage Contents of Copy Session Management Information Table

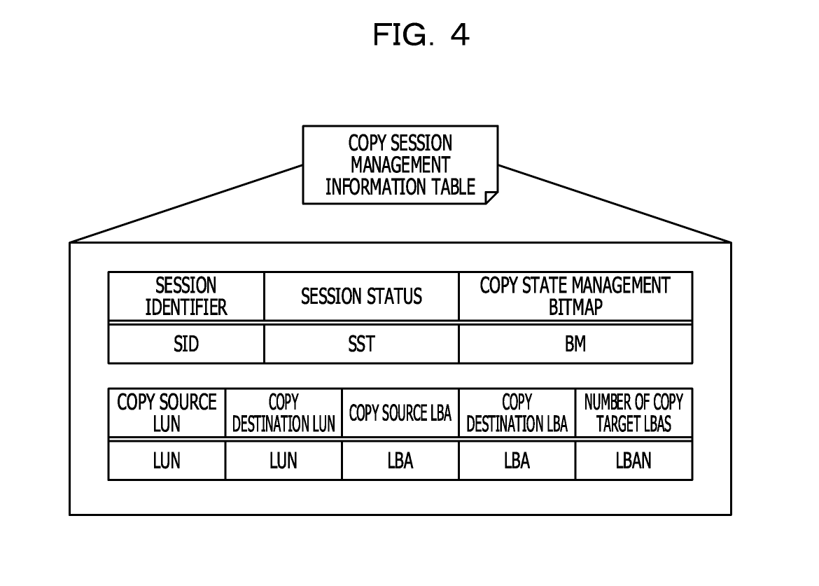

Next, description will be made regarding an example of the storage contents of the copy session management information table, with reference to FIG. 4. The copy session management information table is specifically realized with the memory 212, for example.

FIG. 4 is an explanatory diagram illustrating an example of the storage contents of the copy session management information table. The copy session management information table is a table to store copy session management information. The copy session management information is information indicating a range where remote copying is performed. Data to be copied in a copy session may be data of each buffer-set or may be data stored in multiple buffer-sets, for example.

The copy session management information table includes a “session identifier” item and a “session status” item. Also, the copy session management information table includes a “copy source LUN” item, a “copy destination LUN” item, a “copy source LBA” item, a “copy destination LBA” item, a “number of copy target LBAs” item, and a “copy state management bitmap” item.

A number that indicates session is stored in the “session identifier” item. A state of session such as under transmission, waiting for transmission, or the like is stored in the “session status” item. A logical unit number of a volume 123 within the own device is stored in the “copy source LUN” item. A logical unit number of a volume 123 within the copy destination device is stored in the “copy destination LUN” item.

A logical block address within a LUN of the “copy source LUN” item is stored in the “copy source LBA” item. A logical block address within a LUN of the “copy destination LUN” item is stored in the “copy destination LBA” item. Each LUN and each LBA are set, for example, by a user of the host device 230 by inputting a dedicated command to the host device 230.

A bit flag that indicates whether or not copying of a LUN and a LBA within a copy range has been completed is stored in the “copy state management bitmap” item. Therefore, when a certain LBA is in an “uncopied” state, the corresponding bit is set to on, and when the LBA is in a “copied” state, the corresponding bit is set to off.

Storage Contents of Buffer Management Information Table

Next, description will be made regarding an example of the storage contents of the buffer management information table, with reference to FIG. 5. The buffer management information table is specifically realized with the memory 212, for example.

FIG. 5 is an explanatory diagram illustrating an example of the storage contents of the buffer management information table. The buffer management information table is a table where BIT information is stored. The BIT information is address information of data stored in the buffer.

The buffer management information table includes a “status” item, a “copy source LUN” item, a “copy destination LUN” item, a “copy source LBA” item, a “copy destination LBA” item, and a “number of blocks” item.

Information that indicates a storage state of data is stored in the “status” item. The information that indicates a storage state is information that indicates a “stored” state, or information that indicates an “unstored” state. Address information of a copy source of data stored in the buffer is stored in the “copy source LUN” item and “copy source LBA” item. Address information of a copy destination is stored in the “copy destination LUN” item and “copy destination LBA” item.

Storage Contents of Device Management Information Table

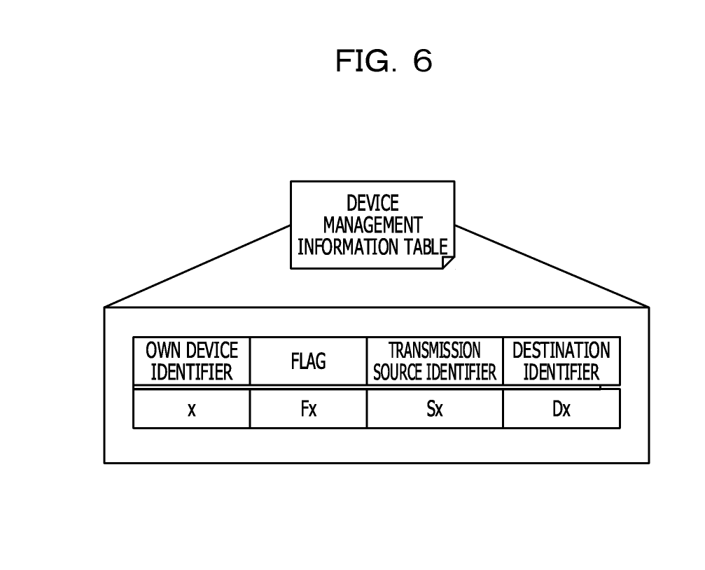

Next, an example of the device management information table will be described with reference to FIG. 6. The device management information table is specifically realized with the memory 212, for example.

FIG. 6 is an explanatory diagram illustrating an example of the storage contents of the device management information table. The device management information table is a table where device management information is stored. The device management information is information that indicates a connection relation with another device.

The device management information table includes an “own device identifier” item, a “flag” item, a “transmission source identifier” item, and a “destination identifier” item.

Identification information of the own device is stored in the “own device identifier” item. Information that indicates a connection state regarding the own device is stored in the “flag” item. The information that indicates a connection state is, for example, information that indicates whether or not there is connection with a transmission source and whether or not there is connection with a transmission destination. Identification information of a computer 200 serving as a transmission source of data is stored in the “transmission source identifier” item. Identification information of a computer 200 serving as a transmission destination of data is stored in the “destination identifier” item.

Storage Contents of Buffer Control Management Information Table

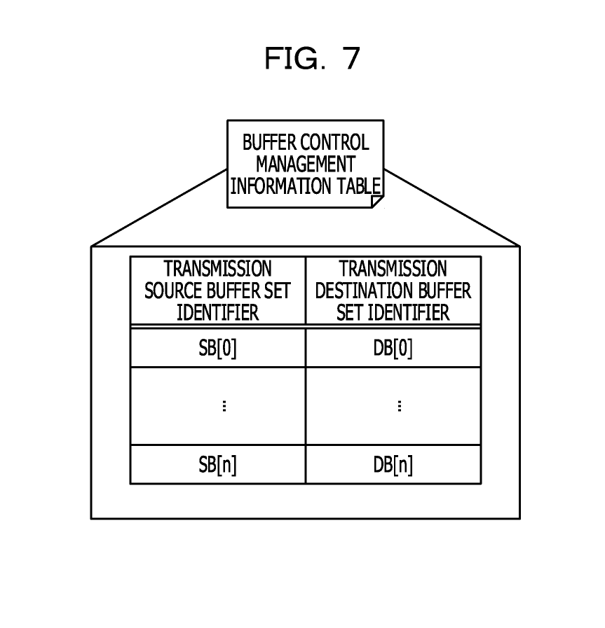

Next, an example of the storage contents of the buffer control management information table will be described with reference to FIG. 7. The buffer control management information table is specifically realized the memory 212, for example.

FIG. 7 is an explanatory diagram illustrating an example of the storage contents of the buffer control management information table. The buffer control management information table is a table where buffer control management information is stored. The buffer control management information is information that indicates a correspondence relation between the buffers of two computers 200.

According to the buffer control management information, buffers of two computers 200 (for example, the relay device 120 and the reception device 130) are correlated, and the order of storing data from the buffers of respective computers 200 in the volumes of the respective computers 200 is guaranteed.

The buffer control management information table includes a “transmission source buffer-set identifier” item, and a “transmission destination buffer-set identifier” item.

Information for identifying a buffer-set serving as a transmission source is stored in the “transmission source buffer-set identifier” item. Information for identifying a buffer-set serving as a transmission destination is stored in the “transmission destination buffer-set identifier” item.

The buffer control management information table may be stored in each computer 200 beforehand. Also, the buffer control management information table may be set by executing negotiation processing between computers 200 before transmission of data.

The relay device 120 includes, for example, two tables of the buffer control management information table regarding the transmission device 110 and relay device 120 and the buffer control management information table regarding the relay device 120 and reception device 130.

Functional Configuration Example of Relay Device 120

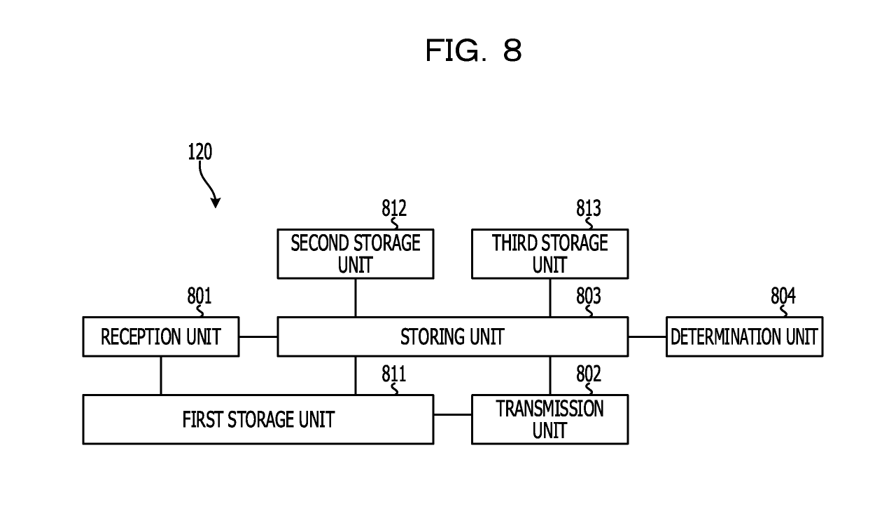

Next, a functional configuration example of the relay device 120 will be described with reference to FIG. 8. FIG. 8 is a block diagram illustrating a functional configuration example of the relay device 120. The relay device 120 has a configuration including a reception unit 801, a transmission unit 802, a storing unit 803, and a determination unit 804. With regard to the reception unit 801, transmission unit 802, storing unit 803, and determination unit 804, the corresponding function is specifically realized by causing the CPU 211 to execute a program stored in a storage device such as the memory 212 illustrated in FIG. 2, or by the CA 213 or RA 214, for example.

Here, the relay device 120 has a function to transmit a data group received from a transmission source to a transmission destination. Also, the relay device 120 has a function to evacuate some data of a data group received from a transmission source to an evacuation destination. Also, the relay device 120 has a function to evacuate subsequent data of the data group to the evacuation destination when there is data in the evacuation destination.

Also, the relay device 120 has a function to restore evacuated data. Also, the relay device 120 has a function to perform mirroring of a data group received from a transmission source. Also, the relay device 120 has a function to transmit a response to a transmission source.

First, description will be made regarding the function to transmit a data group received from a transmission source to a transmission destination. The function to transmit to a transmission destination is specifically realized by a first storage unit 811, the reception unit 801, and the transmission unit 802, for example.

The reception unit 801 receives a data group from a transmission source and stores the received data group in the first storage unit 811. The transmission source mentioned here is the above-mentioned transmission device 110 or another relay device 120, for example. The data mentioned here is data stored in a buffer-set, for example.

The first storage unit 811 mentioned here is a storage device including a first storage region and a second storage region. The first storage region stores data to be transmitted to a transmission destination. The second storage region stores data to be evacuated. The first storage unit 811 is the above-mentioned transfer buffer 121, for example. The transmission destination mentioned here is the above-mentioned reception device 130 or another relay device 120, for example.

The data to be transmitted mentioned here is, among data waiting for transmission, data whose transmission order is equal to or earlier than a predetermined order. The data to be evacuated mentioned here is, among data waiting for transmission, data whose transmission order is later than the predetermined order. The first storage region mentioned here consists of multiple regions each having a predetermined data amount, for example, the above-mentioned multiple buffer-sets.

The predetermined data amount mentioned here may be data amount set by a user of the relay device 120, or may be data amount determined by the relay device 120, for example. The second storage region mentioned here consists of multiple regions each having the predetermined data amount, for example, the above-mentioned multiple buffer-sets.

The first storage region mentioned here may be a storage region of which the storage range is fixed in the first storage unit 811, or may be a storage region of which the storage range varies in the first storage unit 811. The second storage region mentioned here may be a storage region of which the storage range is fixed in the first storage unit 811, or may be a storage region of which the storage range varies in the first storage unit 811.

The reception unit 801 specifically causes the first storage unit 811 to store a data group in the first storage region in accordance with storing order, for example. The storing order mentioned here is order agreeing with storing order in which a transmission source stores the data group in a storage device of the transmission source, for example, in the volume 113 of the transmission device 110. The storing order mentioned here is order also agreeing with storing order in which a transmission destination stores the data group in a storage device of the transmission destination, for example, in the volume 133 of the reception device 130.

Also, the storing order mentioned here is order also serving as storing order to the second storage unit 812. The storing order is determined by negotiation with a transmission source, for example. Also, the storing order may be reception order from a transmission source, for example.

The reception unit 801 more specifically receives multiple data from the transmission device 110, for example. The reception unit 801 collects the received data into predetermined data amount worth of data d1, and stores the collected data in a buffer-set along with BIT information.

Now, it is assumed that predetermined data amount worth of data d1 to d4 is data stored in the first storage region of the transfer buffer 121, and predetermined data amount worth of data d5 and d6 is data not stored in the first storage region of the transfer buffer 121.

After storing data in a buffer-set, the reception unit 801 correlates the buffer-set in the transfer buffer 121 with a buffer-set in a buffer that a transmission destination has, by negotiation with the transmission destination. The reception unit 801 stores data that indicates the correlated buffer-sets in the buffer control management information table, for example. Thus, the transmission unit 802 may transmit the data stored in the first storage region along with BIT information.

The transmission unit 802 transmits the data stored in the first storage region to a transmission destination. The transmission unit 802 specifically stores, each time data is stored in a buffer-set serving as the first storage region of the transfer buffer 121, a transmission request regarding the stored data in a transmission queue, for example. Next, the transmission unit 802 sequentially dequeues a transmission request from the top of the transmission queue, and according to the dequeued transmission request, starts transmission of data requested to be transmitted to the reception device 130.

Also, in the event that there are multiple transmission requests in the transmission queue, the transmission unit 802 may collect multiple data requested to be transmitted to start transmission of the collected data to the reception device 130 by multiplexing transmission. Thus, the transmission destination may receive the data.

Next, description will be made regarding the function to evacuate, out of a data group received from a transmission source, some data to an evacuation destination. The function to evacuate data to an evacuation destination is specifically realized by the reception unit 801 and storing unit 803, for example.

The reception unit 801 stores, out of the data group, data not stored in the first storage region in the second storage region. The reception unit 801 specifically stores, for example, data d5 not stored in a buffer-set serving as the first storage region of the transfer buffer 121 in a buffer-set serving as the second storage region of the transfer buffer 121 along with BIT information relating to the data d5. Thus, the storing unit 803 may evacuate data stored in the buffer-set serving as the second storage region to the evacuation disk 122.

The storing unit 803 stores data stored in the second storage region by the reception unit 801, in the second storage unit 812 in accordance with the storing order, and deletes the data from the second storage region. Here, the second storage unit 812 is a storage device having a storage region serving as an evacuation destination of data to be evacuated. The second storage unit 812 is specifically the above-mentioned evacuation disk 122, for example.

The deletion mentioned here may be to initialize a storage region of the second storage region, where data to be deleted is stored, or may be to set a deletion flag corresponding to a storage region where data to be deleted is stored to on.

The storing unit 803 specifically stores, for example, data d5 in the evacuation disk 122 along with BIT information relating to the data d5, and deletes the data d5 from the buffer-set serving as the second storage region of the transfer buffer 121. Thus, the storing unit 803 may create a free region in the first storage unit 811.

Next, the function to evacuate, in the event that there is data in the evacuation destination, subsequent data of the data group to the evacuation destination will be described. The function to evacuate subsequent data of the data group to the evacuation destination is specifically realized by the reception unit 801 and storing unit 803, for example.

The reception unit 801 stores, in the event that data stored in the second storage unit 812 by the storing unit 803 remains in the second storage unit 812, the subsequent data of the data group from the transmission source in the second storage region. The reception unit 801 specifically receives data d6 following the data d5, for example.

Here, in the event that the data d5 is stored in the evacuation disk 122, the reception unit 801 stores the data d6 in the second storage region of the transfer buffer 121 along with BIT information relating to the data d6. Thus, the storing unit 803 may evacuate data in the buffer-set serving as the second storage region in the evacuation disk 122 along with the BIT information.

The storing unit 803 stores subsequent data stored in the second storage region in the second storage unit 812 in accordance with the storing order, and deletes the subsequent data from the second storage region. The storing unit 803 specifically stores, for example, data d6 in the evacuation disk 122 along with BIT information relating to the data d6, and deletes the data d6 from the buffer-set serving as the second storage region of the transfer buffer 121. Thus, the storing unit 803 may create a free region in the first storage unit 811.

Next, the function to restore evacuated data will be described. The function to restore evacuated data is specifically realized by the storing unit 803 and determination unit 804, for example.

The determination unit 804 determines whether or not data stored in the second storage unit 812 by the storing unit 803 remains in the second storage unit 812. The determination unit 804 specifically determines, for example, that data d5 and d6 remain in the evacuation disk 122. The determination result is stored in the above-mentioned memory 212, for example. Thus, the storing unit 803 may obtain a trigger to restore data evacuated in the evacuation disk 122 to the transfer buffer 121.

Also, the determination unit 804 determines whether or not a free region has been generated in the first storage region by transmission to a transmission destination. The determination unit 804 specifically determines, for example, as a result of data d1 being transmitted to the reception device 130 by the transmission unit 802 along with BIT information, that a free region has been generated in a buffer-set serving as the first storage region of the transfer buffer 121. The determination result is stored in the above-mentioned memory 212, for example. Thus, the storing unit 803 may obtain a trigger to restore data evacuated in the evacuation disk 122 to the transfer buffer 121.

In the event that determination is made by the determination unit 804 that data remains in the second storage unit 812, and also a free region has been generated in the first storage region, the storing unit 803 stores the data stored in the second storage unit 812 in the free region in accordance with the storing order, and deletes the data from the second storage unit 812.

Now, it is assumed that data d5 and d6 remain in the evacuation disk 122, and also there is a free region in a buffer-set serving as the first storage region of the transfer buffer 121. In this case, the storing unit 803 specifically stores the data d5 stored in the evacuation disk 122 of which the storing order is the earliest in the free region of the buffer-set serving as the first storage region of the transfer buffer 121 along with BIT information relating to the data d5, for example.

Next, the storing unit 803 deletes the data d5 stored in the free region along with the BIT information relating to the data d5 from the evacuation disk 122. Thus, the transmission unit 802 may transmit restored data to a transmission destination.

Also, the storing unit 803 may delete the data d5 stored in the free region along with the BIT information relating to the data d5 from the evacuation disk 122 after storing of the data d5 in the volume 123 is ended, and transmission of the data d5 to the reception device 130 is ended. Thus, in the event that the data d5 has been deleted from the transfer buffer 121 due to operation abnormality before storing of the data d5 in the volume 123 and transmission of the data d5 to the reception device 130 are ended, the relay device 120 may restore the data d5 again.

Next, the function to perform mirroring on a data group received from a transmission source will be described. The function to perform mirroring on a data group received from a transmission source is specifically realized by the storing unit 803, for example.

The storing unit 803 stores a data group received from a transmission source in a third storage unit 813 in accordance with the storing order. The third storage unit 813 mentioned here is a storage device having a storage region serving as a storage destination of the data group to be subjected to mirroring. The third storage unit 813 is specifically the above-mentioned volume 123, for example.

The storing unit 803 specifically sequentially stores data d1 to d4 stored in the first storage region of the transfer buffer 121 in the volume 123 in accordance with the storing order, for example. Here, the storing unit 803 references the BIT information to determine a storing location of the data in the volume 123 and stores the data. Thus, the storing unit 803 may perform mirroring on the data received from a transmission source to the volume 123 within the relay device 120.

Next, the function to transmit a response to a transmission source will be described. The function to transmit a response to a transmission source is specifically realized by the transmission unit 802, for example.

In the event that one of data stored in the first storage region has been transmitted, and also, the one of data has been stored in the third storage unit 813, the transmission unit 802 transmits information that indicates processing completion of the one of data to a transmission source. Specifically, for example, in the event that transmission of data d1 to the reception device 130 has been completed, and also, storing of the data d1 in the volume 123 has been completed, the transmission unit 802 transmits a response that indicates transmission completion and storing completion of the data d1 to the transmission source. Thus, the transmission source may create a free region by deleting the data d1 from the buffer within the own device along with the BIT information relating to the data d1.

Also, in the event that data has been deleted from the second storage region, the transmission unit 802 may transmit information that indicates deletion completion of data stored in the second storage region to a transmission source. Now, it is assumed that data d5 has been evacuated to the evacuation disk 122, and the data d5 has been deleted from a buffer-set serving as the second storage region of the transfer buffer 121. In this case, the transmission unit 802 specifically transmits a response that indicates deletion completion of the data d5 to the transmission device 110, for example. Thus, a transmission source may create a free region by deleting the data d5 from the buffer within the own device along with the BIT information relating to the data d5.

Example of Data Transfer

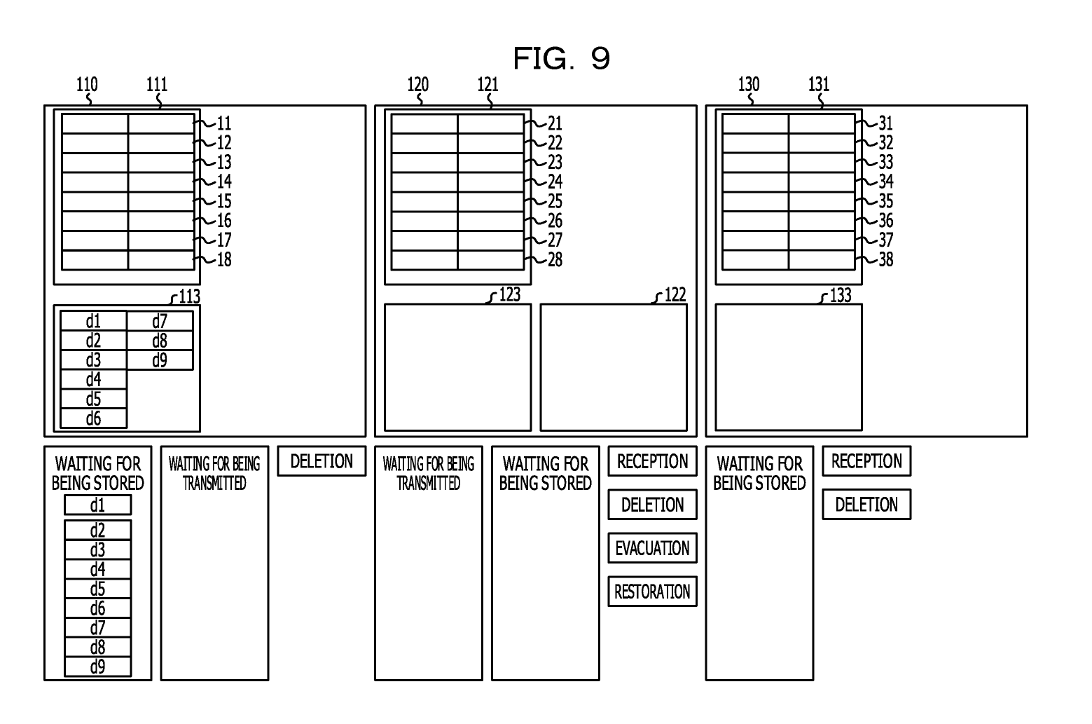

Next, an example of data transfer will be described with reference to FIGS. 9 to 22. Now, it is assumed that the threshold of the transfer buffer 121 is for five buffer-sets worth. Also, it is assumed that copy sessions have been established between the transmission device 110 and the relay device 120, and between the relay device 120 and the reception device 130.

FIGS. 9 to 22 are explanatory diagrams illustrating an example of data transfer. In FIG. 9, the transmission device 110 accepts Write I/O instruction from the host device 230. Each time Write I/O instruction is accepted, the transmission device 110 writes data for which Write I/O instruction has been accepted in a volume 113.

Each time Write I/O instruction is accepted, the transmission device 110 also stores the data for which Write I/O instruction has been accepted and BIT information indicated by the Write I/O instruction in a buffer-set of the transmission buffer 111. The transmission device 110 switches the buffer-set serving as a storage destination when predetermined data amount of data is stored in the buffer-set.

Each time Write I/O instruction is accepted, the transmission device 110 specifically stores, in a storing queue, a storing request regarding data for which Write I/O instruction has been accepted. The transmission device 110 dequeues the storing request from the storing queue, and stores the data for which Write I/O instruction has been accepted and BIT information indicated by the Write I/O instruction, in the buffer-set.

Description on processing of data transfer is started with reference to FIG. 9. The transmission device 110 accepts Write I/O instruction of predetermined data amount of data d1 to d9 from the host device 230, and stores storing requests regarding the data d1 to d9 in the storing queue. Next, the transmission device 110 dequeues the storing request regarding the data d1 which is located in the top of the storing queue, and starts storing of buffer-set data including the data d1 and BIT information relating to the data d1 in a buffer-set 11 of the transmission buffer 111. Hereinafter, buffer-set data including data di (i is a natural number) will be referred to “buffer-set data d0i”. The BIT information relating to the data di is denoted by “(di)” in the drawings.

Here, though the transmission device 110 starts storing of buffer-set data d01 to d09 regarding the data d1 to d9 in the transmission buffer 111 after storing the data d1 to d9 in the volume 113, the processing method is not restricted to this. For example, the transmission device 110 may execute storing of the data d1 to d9 in the volume 113, and storing of the buffer-set data d01 to d09 regarding the data d1 to d9 in the transmission buffer 111 in parallel.

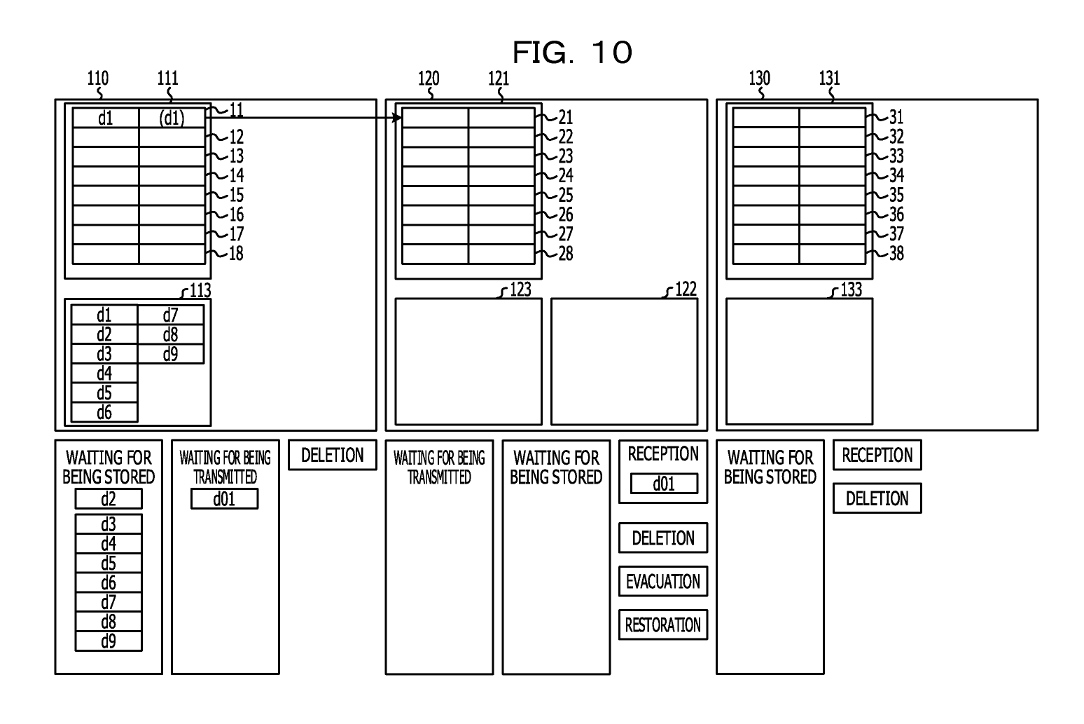

Also, the transmission device 110 may execute storing of the data d1 to d9 in the volume 113 in parallel without processing the data d1 to d9 one at a time. In this case, in the event that there are multiple data, out of the data d1 to d9, to be stored in the same region in the volume 113, the transmission device 110 sequentially stores the multiple data from the preceding data without performing parallel execution. Now, it is assumed that storing of the buffer-set data d01 in the buffer-set 11 of the transmission buffer 111 by the transmission device 110 is completed. With this assumption, the processing is described with reference to FIG. 10.

In FIG. 10, upon storing of the buffer-set data d01 in the transmission buffer 111 being completed, the transmission device 110 dequeues the storing request regarding the data d2 which is located in the top of the storing queue. The transmission device 110 starts storing of the data d2 and BIT information relating to the data d2 in a buffer-set 12 of the transmission buffer 111.

Also, in the event that buffer-set data is stored in the transmission buffer 111, the transmission device 110 starts transmission of the buffer-set data to the relay device 120. Upon storing of the buffer-set data d01 in the transmission buffer 111 being completed, the transmission device 110 specifically stores, in the transmission queue, a transmission request regarding the buffer-set data d01 stored in the transmission buffer 111, for example.

Next, the transmission device 110 dequeues the transmission request regarding the buffer-set data d01 which is located in the top of the transmission queue, and starts transmission of the buffer-set data d01 to the relay device 120. Here, for simplification of description, transmission requests will be processed one at a time, but the processing method is not restricted to this. For example, the transmission device 110 may collect multiple transmission requests to transmit, by multiplexing transmission, multiple data requested to be transmitted.

Here, the transmission device 110 and relay device 120 execute negotiation to correlate a buffer-set 21 serving as a storing destination of the buffer-set data stored in the buffer-set 11, thereby performing data communication. For example, data that indicates correspondence relation between buffer-sets is stored as a record of the buffer control management information table.

Hereinafter, for simplification of description, description regarding how to correlate buffer-sets by negotiation will be omitted. The relay device 120 starts reception of the buffer-set data d01, and starts storing of the buffer-set data d01 in the buffer-set 21 of the transfer buffer 121.

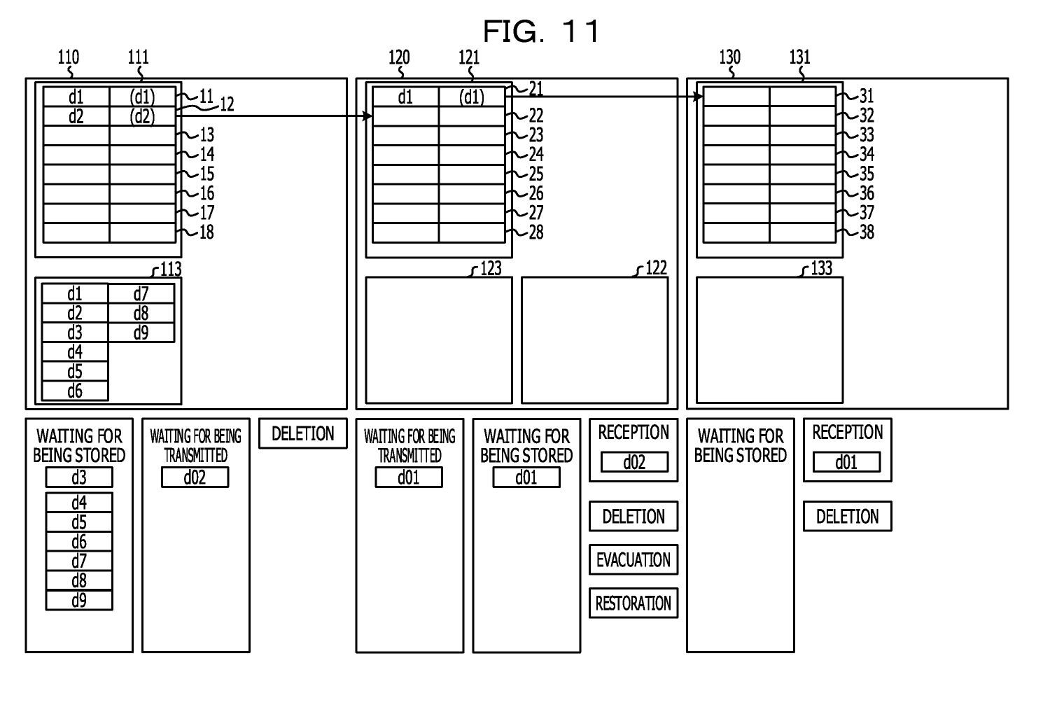

Now, it is assumed that transmission of the buffer-set data d01 to the relay device 120 by the transmission device 110, and storing of the data d2 and BIT information relating to the data d2 in the transmission buffer 111 by the transmission device 110 are completed. Also, it is assumed that storing of the buffer-set data d01 in the transfer buffer 121 by the relay device 120 is completed. With these assumptions, the processing is described with reference to FIG. 11.

In FIG. 11, the transmission device 110 starts, in the same way as with FIG. 10, storing of the data d3 and BIT information relating to the data d3 in a buffer-set 13 of the transmission buffer 111. Also, the transmission device 110 starts transmission of the buffer-set data d02 to the relay device 120.

The relay device 120 starts reception of the buffer-set data d02, and starts storing of the buffer-set data d02 in a buffer-set 22 of the transfer buffer 121. Since the buffer-set data d01 has been stored in the transfer buffer 121, the relay device 120 generates a transmission request for transmitting the buffer-set data d01 to the reception device 130, and also generates a storing request for storing the data d1 in the volume 123.

The relay device 120 specifically stores, in the transmission queue, a transmission request regarding the buffer-set data d01 stored in the transfer buffer 121, and stores, in the storing queue, a storing request regarding the buffer-set data d01 stored in the transfer buffer 121, for example.

Next, the relay device 120 dequeues the transmission request regarding the buffer-set data d01 which is located in the top of the transmission queue, and starts transmission of the buffer-set data d01 to the reception device 130. Also, the relay device 120 dequeues the storing request regarding the buffer-set data d01 which is located in the top of the storing queue, and starts storing of the data d1 in the volume 123.

The reception device 130 starts reception of the buffer-set data d01, and stores received part of the buffer-set data d01 in a buffer-set 31 of the reception buffer 131.

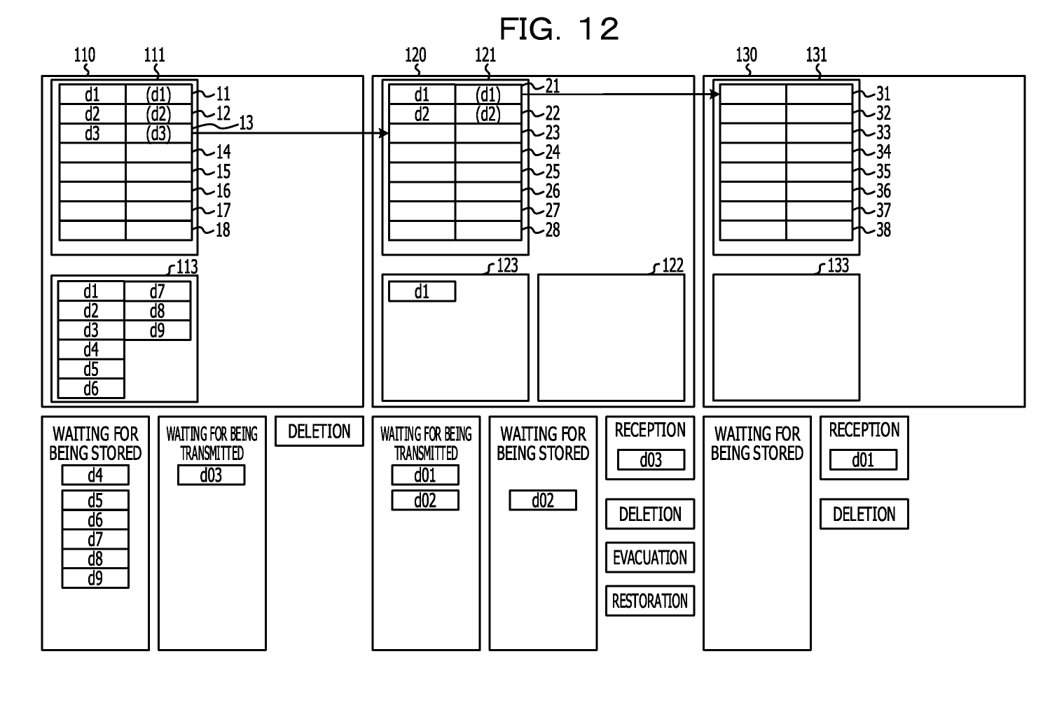

Now, it is assumed that transmission of the buffer-set data d02 to the relay device 120 by the transmission device 110, and storing of the data d3 and BIT information relating to the data d3 in the transmission buffer 111 by the transmission device 110 are completed. Also, it is assumed that storing of the buffer-set data d02 in the transfer buffer 121 by the relay device 120 is completed, and transmission of the buffer-set data d01 by the relay device 120 is not completed. With these assumptions, the processing is described with reference to FIG. 12.

In FIG. 12, the transmission device 110 starts, in the same way as with FIG. 10, storing of the data d4 and BIT information relating to the data d4 in a buffer-set 14 of the transmission buffer 111. Also, the transmission device 110 starts transmission of the buffer-set data d03 to the relay device 120.

The relay device 120 stores, in the transmission queue, a transmission request regarding the buffer-set data d02 stored in the transfer buffer 121, and stores, in the storing queue, a storing request regarding the buffer-set data d02 stored in the transfer buffer 121.

Next, the relay device 120 starts reception of the buffer-set data d03, and starts storing of the buffer-set data d03 in a buffer-set 23 of the transfer buffer 121.

Also, the relay device 120 continues transmission of the buffer-set data d01 which has not been completely transmitted. The reception device 130 continues reception of the buffer-set data d01, and stores received part of the buffer-set data d01 in the buffer-set 31 of the reception buffer 131.

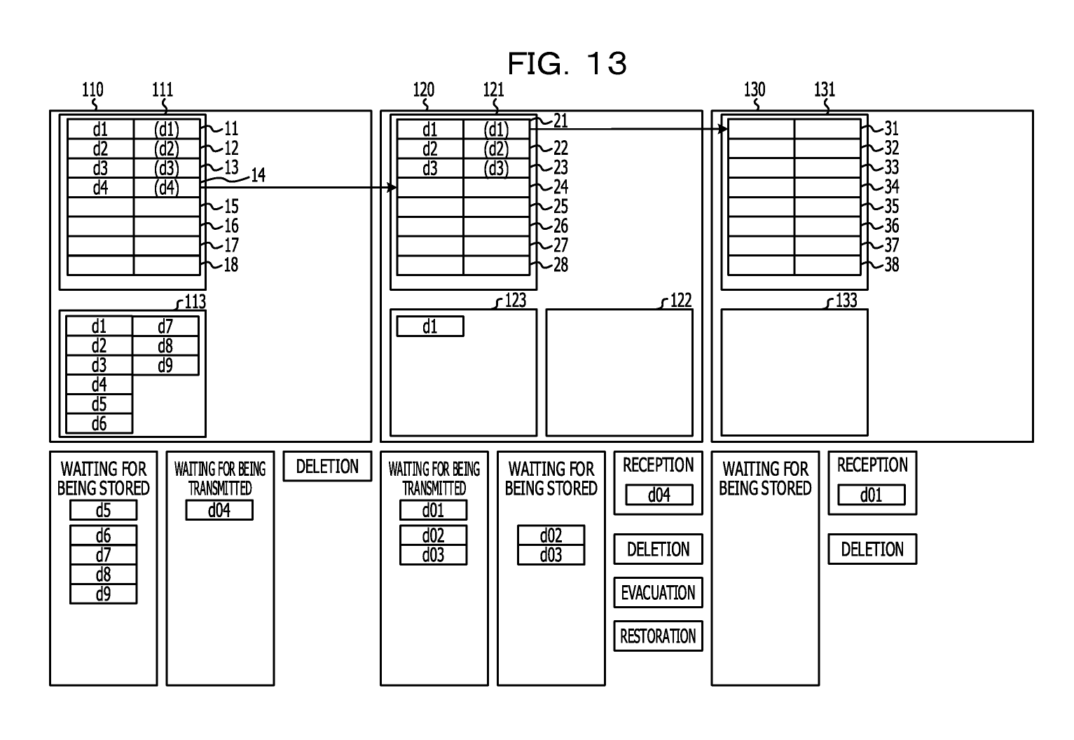

Now, it is assumed that transmission of the buffer-set data d03 to the relay device 120 by the transmission device 110, and storing of the data d4 and BIT information relating to the data d4 in the transmission buffer 111 by the transmission device 110 are completed. Also, it is assumed that storing of the buffer-set data d03 in the transfer buffer 121 by the relay device 120 has been completed, and transmission of the buffer-set data d01 by the relay device 120 is not completed. With these assumptions, the processing is described with reference to FIG. 13.

In FIG. 13, the transmission device 110 starts, in the same way as with FIG. 10, storing of the data d5 and BIT information relating to the data d5 in a buffer-set 15 of the transmission buffer 111. Also, the transmission device 110 starts transmission of the buffer-set data d04 to the relay device 120.

The relay device 120 stores, in the transmission queue, a transmission request regarding the buffer-set data d03 stored in the transfer buffer 121, and stores, in the storing queue, a storing request regarding the buffer-set data d03 stored in the transfer buffer 121.

Next, the relay device 120 starts reception of the buffer-set data d04, and starts storing of the buffer-set data d04 in a buffer-set 24 of the transfer buffer 121.

Also, the relay device 120 continues transmission of the buffer-set data d01 which has not been completely transmitted. The reception device 130 continues reception of the buffer-set data d01, and stores received part of the buffer-set data d01 in the buffer-set 31 of the reception buffer 131.

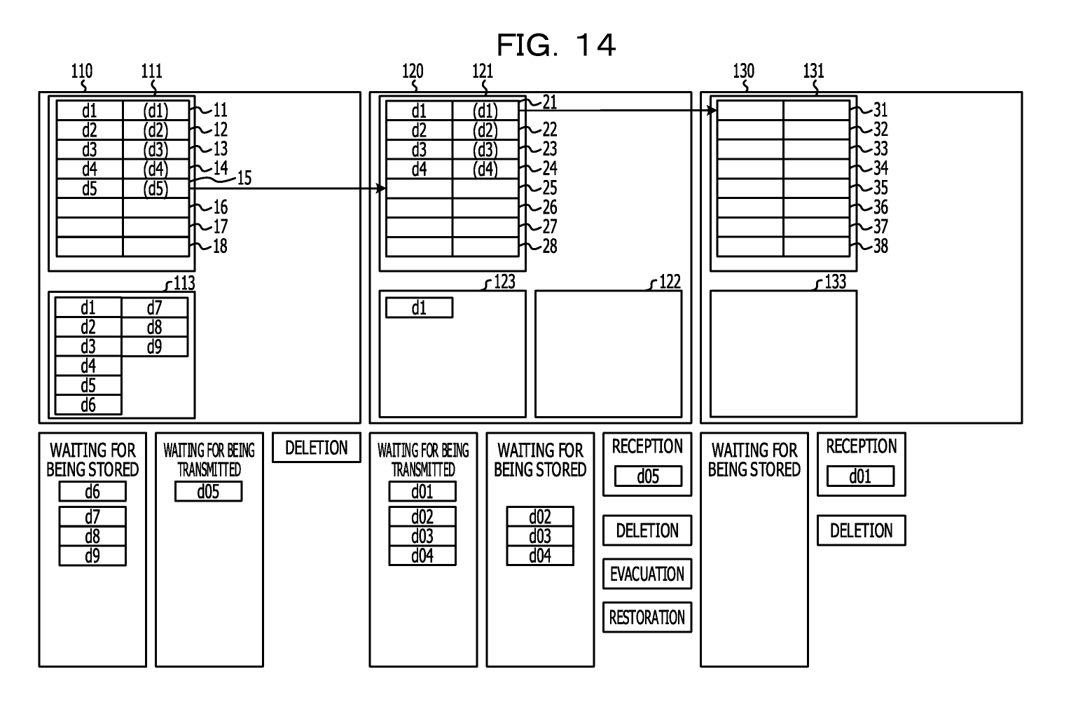

Now, it is assumed that transmission of the buffer-set data d04 to the relay device 120 by the transmission device 110, and storing of the data d5 and BIT information relating to the data d5 in the transmission buffer 111 by the transmission device 110 are completed. Also, it is assumed that storing of the buffer-set data d04 to the transfer buffer 121 by the relay device 120 has been completed, and transmission of the buffer-set data d01 by the relay device 120 is not completed. With these assumptions, the processing is described with reference to FIG. 14.

In FIG. 14, the transmission device 110 starts, in the same way as with FIG. 10, storing of the data d6 and BIT information relating to the data d6 in a buffer-set 16 of the transmission buffer 111. Also, the transmission device 110 starts transmission of the buffer-set data d05 to the relay device 120.

The relay device 120 stores, in the transmission queue, a transmission request regarding the buffer-set data d04 stored in the transfer buffer 121, and stores, in the storing queue, a storing request regarding the buffer-set data d04 stored in the transfer buffer 121.

Next, the relay device 120 starts reception of the buffer-set data d05, and starts storing of the buffer-set data d05 in a buffer-set 25 of the transfer buffer 121.

Also, the relay device 120 continues transmission of the buffer-set data d01 which has not been completely transmitted. The reception device 130 continues reception of the buffer-set data d01, and stores received part of the buffer-set data d01 in the buffer-set 31 of the reception buffer 131.

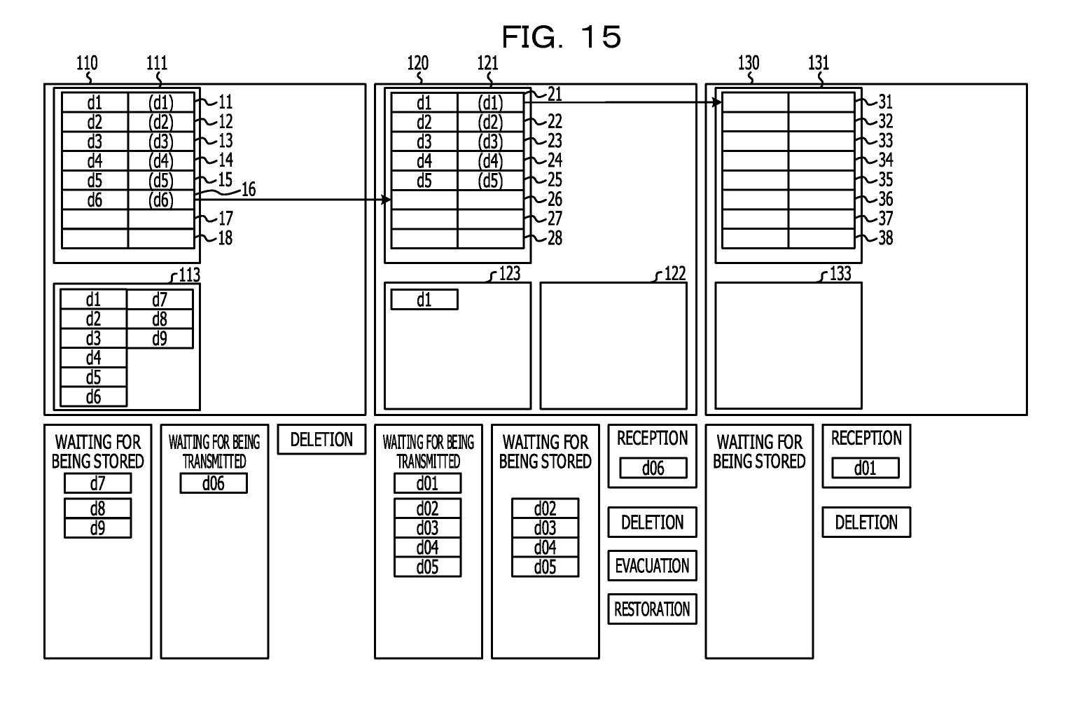

Now, it is assumed that transmission of the buffer-set data d05 to the relay device 120 by the transmission device 110, and storing of the data d6 and BIT information relating to the data d6 in the transmission buffer 111 by the transmission device 110 are completed. Also, it is assumed that that storing of the buffer-set data d05 in the transfer buffer 121 by the relay device 120 has been completed, and transmission of the buffer-set data d01 by the relay device 120 is not completed. With these assumptions, the processing is described with reference to FIG. 15.

In FIG. 15, the transmission device 110 starts, in the same way as with FIG. 10, storing of the data d7 and BIT information relating to the data d7 in a buffer-set 17 of the transmission buffer 111. Also, the transmission device 110 starts transmission of the buffer-set data d06 to the relay device 120.

The relay device 120 stores, in the transmission queue, a transmission request regarding the buffer-set data d05 stored in the transfer buffer 121, and stores, in the storing queue, a storing request regarding the buffer-set data d05 stored in the transfer buffer 121.

Next, the relay device 120 starts reception of the buffer-set data d06, and starts storing of the buffer-set data d06 in a buffer-set 26 of the transfer buffer 121.

Also, the relay device 120 continues transmission of the buffer-set data d01 which has not been completely transmitted. The reception device 130 continues reception of the buffer-set data d01, and stores received part of the buffer-set data d01 in the buffer-set 31 of the reception buffer 131.

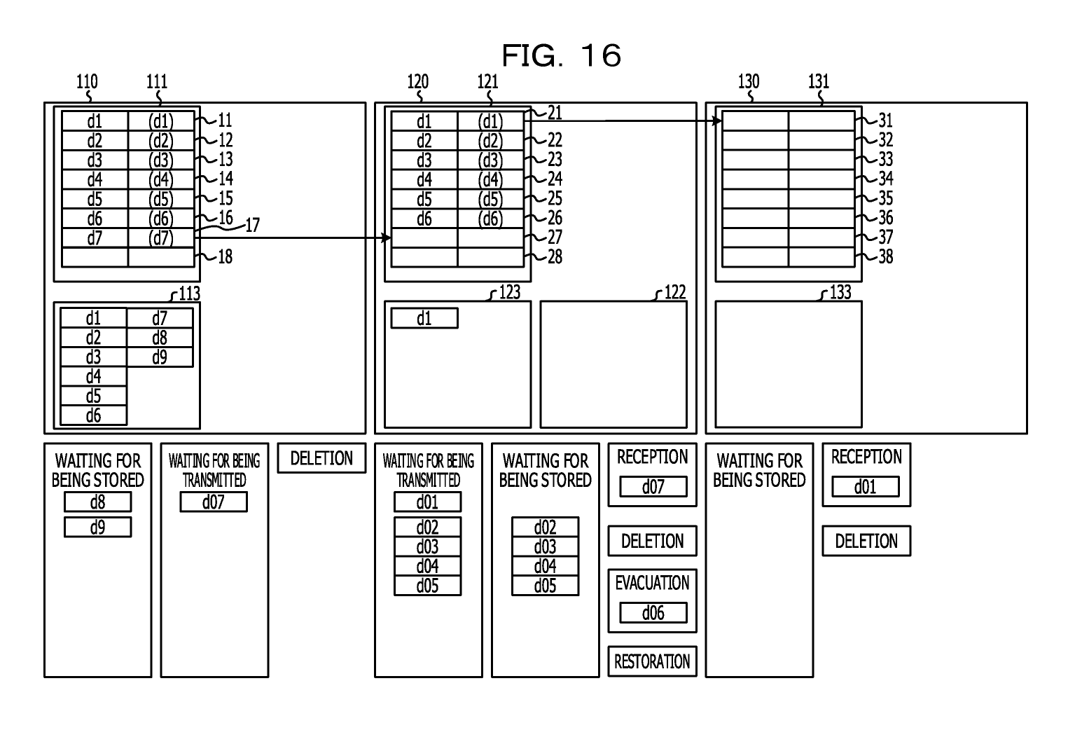

Now, it is assumed that transmission of the buffer-set data d06 to the relay device 120 by the transmission device 110, and storing of the data d7 and BIT information relating to the data d7 in the transmission buffer 111 by the transmission device 110 are completed. Also, it is assumed that storing of the buffer-set data d06 in the transfer buffer 121 by the relay device 120 is completed, and transmission of the buffer-set data d01 by the relay device 120 is not completed. With these assumptions, the processing is described with reference to FIG. 16.

In FIG. 16, the transmission device 110 starts, in the same way as with FIG. 10, storing of the data d8 and BIT information relating to the data d8 in a buffer-set 18 of the transmission buffer 111. Also, the transmission device 110 starts transmission of the buffer-set data d07 to the relay device 120.

The relay device 120 detects that the usage amount of the transfer buffer 121 exceeds the threshold by the buffer-set data d06 being stored in the transfer buffer 121. Next, the relay device 120 starts storing of the buffer-set data d06 stored in the transfer buffer 121 in the evacuation disk 122. Thus, the relay device 120 may secure a free region in the transfer buffer 121. Also, the relay device 120 starts reception of the buffer-set data d07, and starts storing of the buffer-set data d07 in a buffer-set 27 of the transfer buffer 121.

Also, the relay device 120 continues transmission of the buffer-set data d01 which has not been completely transmitted. The reception device 130 continues reception of the buffer-set data d01, and stores received part of the buffer-set data d01 in the buffer-set 31 of the reception buffer 131.

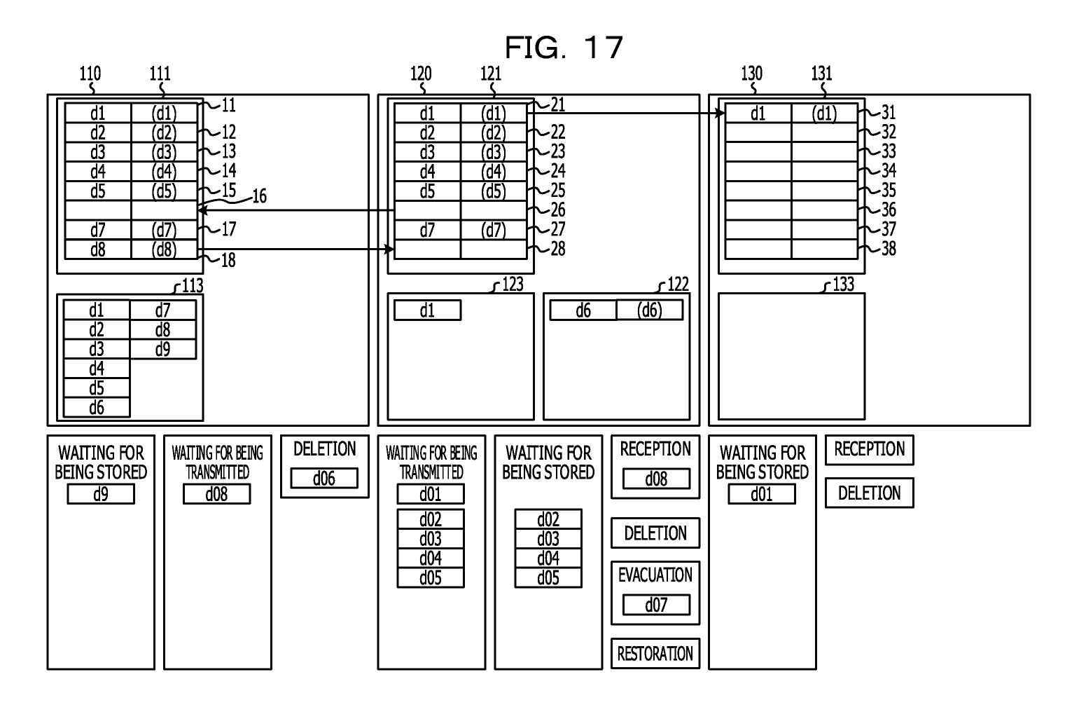

Now, it is assumed that transmission of the buffer-set data d07 to the relay device 120 by the transmission device 110, and storing of the data d8 and BIT information relating to the data d8 in the transmission buffer 111 by the transmission device 110 are completed. Also, it is assumed that storing of the buffer-set data d07 in the transfer buffer 121 by the relay device 120, and storing of the buffer-set data d06 in the evacuation disk 122 by the relay device 120 are completed, and transmission of the buffer-set data d01 by the relay device 120 is not completed. With these assumptions, the processing is described with reference to FIG. 17.

In FIG. 17, upon evacuation of the buffer-set data d06 being completed, the relay device 120 transmits a response that indicates evacuation completion of the buffer-set data d06 to the transmission device 110. Upon receiving the response that indicates evacuation completion of the buffer-set data d06, the transmission device 110 deletes the buffer-set data d06 from the transmission buffer 111, and transmits a response to the relay device 120. Upon receiving the response from the transmission device 110, the relay device 120 deletes the buffer-set data d06 from the transfer buffer 121.

The transmission device 110 starts, in the same way as with FIG. 10, storing of the data d9 and BIT information relating to the data d9 in the buffer-set 16 of the transmission buffer 111. Also, the transmission device 110 starts transmission of the buffer-set data d08 to the relay device 120.

The relay device 120 detects that the usage amount of the transfer buffer 121 exceeds the threshold by the buffer-set data d07 being stored in the transfer buffer 121. Next, the relay device 120 starts storing of the buffer-set data d07 stored in the transfer buffer 121 in the evacuation disk 122. Also, the relay device 120 starts reception of the buffer-set data d08, and starts storing of the buffer-set data d08 in a buffer-set 28 of the transfer buffer 121.

Also, the relay device 120 ends transmission of the buffer-set data d01. The reception device 130 ends reception of the buffer-set data d01, and ends storing of the buffer-set data d01 in the buffer-set 31 of the reception buffer 131.

Next, the reception device 130 starts, when buffer-set data is stored in the reception buffer 131, storing of data included in the buffer-set data in the volume 133. The reception device 130 specifically stores, in the storing queue, a storing request regarding the buffer-set data d01, for example. Next, the reception device 130 dequeues the storing request regarding the buffer-set data d01 which is located in the top of the storing queue, and starts storing of the data d1 in the volume 133.

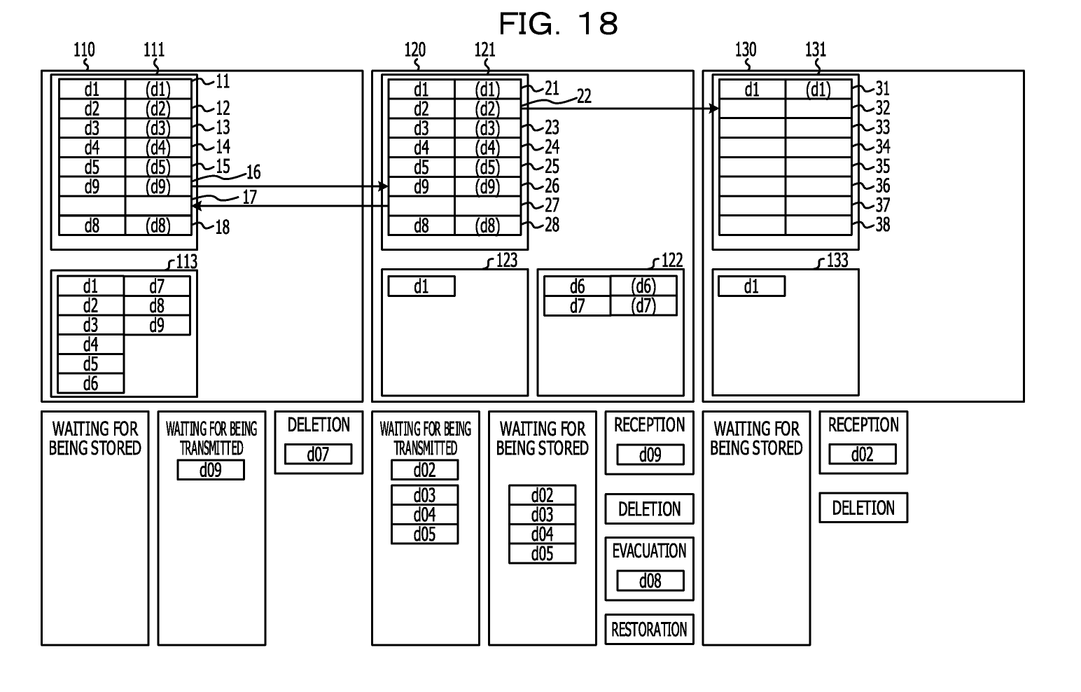

Now, it is assumed that transmission of the buffer-set data d08 to the relay device 120 by the transmission device 110, and storing of the data d9 and BIT information relating to the data d9 in the transmission buffer 111 by the transmission device 110 are completed. Also, it is assumed that storing of the buffer-set data d08 in the transfer buffer 121 by the relay device 120, and storing of the buffer-set data d07 in the evacuation disk 122 by the relay device 120 are completed, and storing of the data d1 in the volume 133 by the reception device 130 is completed. With these assumptions, the processing is described with reference to FIG. 18.

In FIG. 18, upon evacuation of the buffer-set data d07 being completed, the relay device 120 transmits a response that indicates evacuation completion of the buffer-set data d07 to the transmission device 110. Upon receiving the response that indicates evacuation completion of the buffer-set data d07, the transmission device 110 deletes the buffer-set data d07 from the transmission buffer 111, and transmits a response to the relay device 120. Upon receiving the response from the transmission device 110, the relay device 120 deletes the buffer-set data d07 from the transfer buffer 121.

The transmission device 110 ends transmission of the buffer-set data d08, and starts transmission of the buffer-set data d09 to the relay device 120.

The relay device 120 detects that the usage amount of the transfer buffer 121 exceeds the threshold by the buffer-set data d08 being stored in the transfer buffer 121. Next, the relay device 120 stores the buffer-set data d08 stored in the transfer buffer 121 in the evacuation disk 122.

Also, the relay device 120 starts transmission of the buffer-set data d02 to the reception device 130. The reception device 130 starts reception of the buffer-set data d02. Also, the relay device 120 starts reception of the buffer-set data d09, and starts storing of the buffer-set data d09 in the buffer-set 26 of the transfer buffer 121.

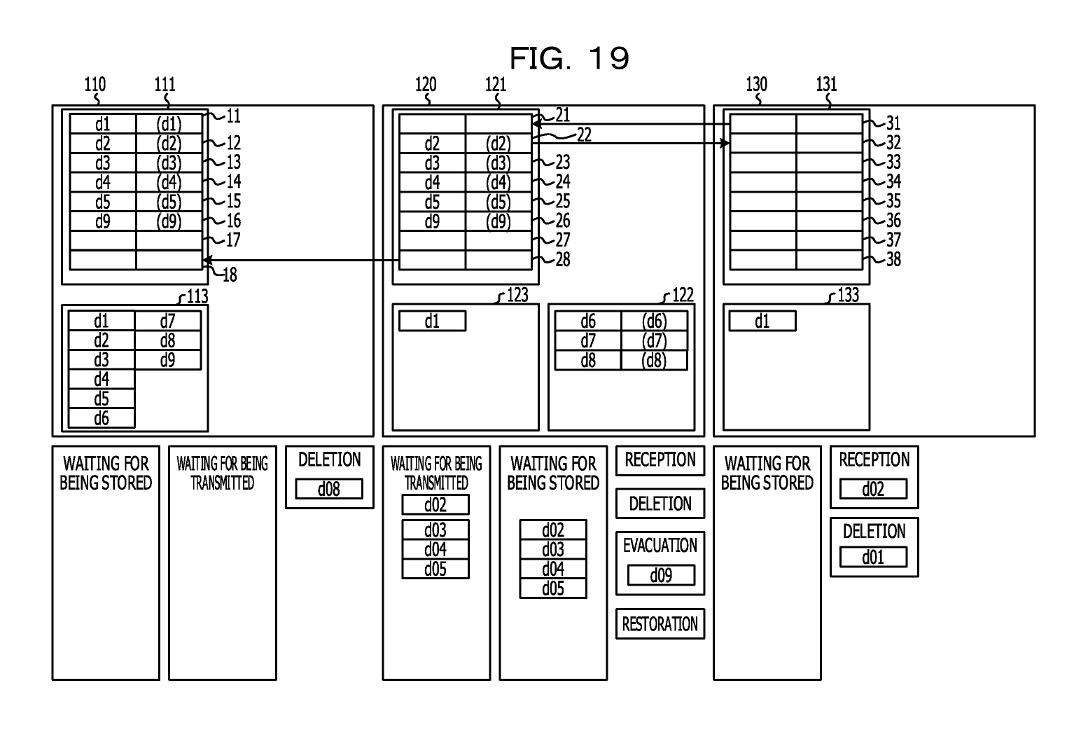

Now, it is assumed that transmission of the buffer-set data d09 to the relay device 120 by the transmission device 110 is completed. Also, it is assumed that storing of the buffer-set data d09 in the transfer buffer 121 by the relay device 120, and storing of the buffer-set data d08 in the evacuation disk 122 by the relay device 120 are completed, and transmission of the buffer-set data d02 by the relay device 120 is not completed. With these assumptions, the processing is described with reference to FIG. 19.

In FIG. 19, upon evacuation of the buffer-set data d08 being completed, the relay device 120 transmits a response that indicates evacuation completion of the buffer-set data d08 to the transmission device 110. Upon receiving the response that indicates evacuation completion of the buffer-set data d08, the transmission device 110 deletes the buffer-set data d08 from the transmission buffer 111, and transmits a response to the relay device 120. Upon receiving the response from the transmission device 110, the relay device 120 deletes the buffer-set data d08 from the transfer buffer 121.

Upon storing of the data d1 in the volume 133 being completed, the reception device 130 transmits a response that indicates storing completion of the buffer-set data d01 to the relay device 120. Upon receiving the response that indicates storing completion of the buffer-set data d01 from the reception device 130, the relay device 120 transmits a response that indicates that the response from the reception device 130 has been received, to the reception device 130. Upon receiving the response from the relay device 120, the reception device 130 deletes the buffer-set data d01 from the reception buffer 131.

Upon receiving the response that indicates storing completion of the buffer-set data d01 from the reception device 130, the relay device 120 determines that transmission of the buffer-set data d01 to the reception device 130 and storing of the data d1 in the volume 123 are completed.

Also, the relay device 120 detects that the usage amount of the transfer buffer 121 exceeds the threshold by the buffer-set data d09 being stored in the transfer buffer 121. Next, the relay device 120 stores the buffer-set data d09 in the evacuation disk 122. Also, the relay device 120 continues transmission of the buffer-set data d02 which has not been completely transmitted.

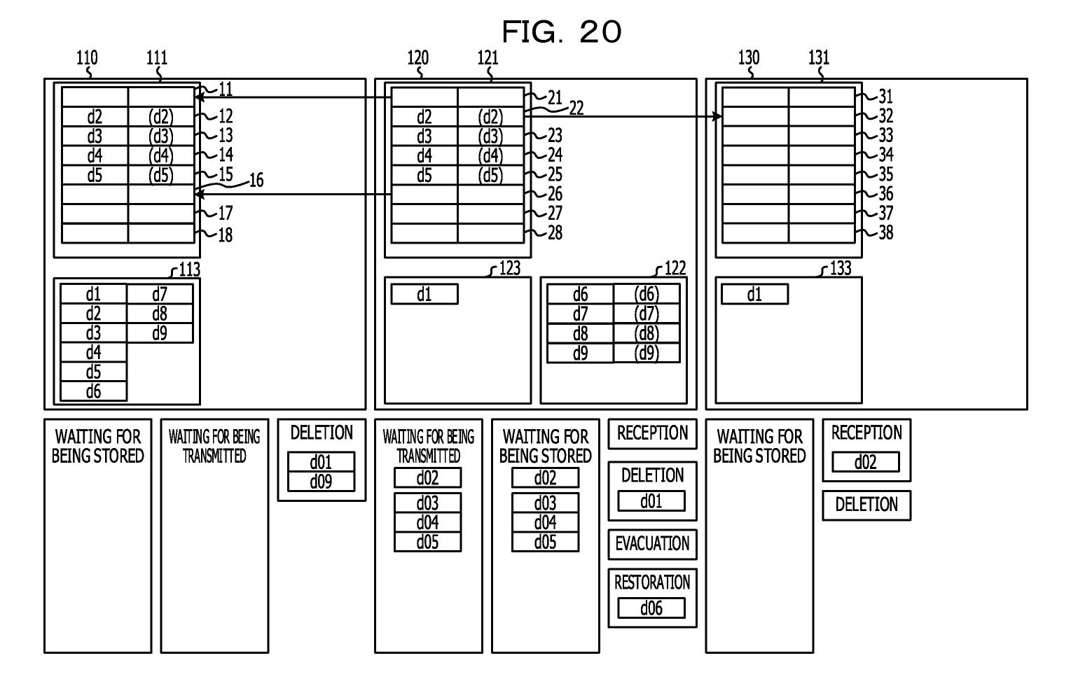

Now, it is assumed that storing of the buffer-set data d09 in the evacuation disk 122 by the relay device 120 is completed, and transmission of the buffer-set data d02 by the relay device 120 is not completed. With these assumptions, the processing is described with reference to FIG. 20.

In FIG. 20, upon transmission of the buffer-set data d01 to the reception device 130 and storing of the data d1 in the volume 123 being completed, the relay device 120 transmits a response that indicates transmission completion of the buffer-set data d01 to the reception device 130 and storing completion of the data d1 in the volume 123, to the transmission device 110.

Upon receiving the response that indicates transmission completion of the buffer-set data d01 to the reception device 130 and storing completion of the data d1 to the volume 123, the transmission device 110 deletes the buffer-set data d01 from the transmission buffer 111, and transmits a response of deletion completion to the relay device 120.

Upon receiving the response from the transmission device 110, the relay device 120 dequeues the storing request regarding the buffer-set data d02 which is located in the top of the storing queue, and starts storing of the data d2 in the volume 123. Also, the relay device 120 executes deletion of the buffer-set data d01 from the transfer buffer 121.

Next, upon a free region being generated in the transfer buffer 121 by deletion of the buffer-set data d01, the relay device 120 starts restoring of the buffer-set data d06 to the transfer buffer 121. Also, the relay device 120 continues transmission of the buffer-set data d02. The reception device 130 continues reception of the buffer-set data d02.

Upon evacuation of the buffer-set data d09 being completed, the relay device 120 transmits a response that indicates evacuation completion of the buffer-set data d09 to the transmission device 110. Upon receiving the response that indicates evacuation completion of the buffer-set data d09, the transmission device 110 deletes the buffer-set data d09 from the transmission buffer 111. Upon receiving a notification for deletion of the buffer-set data d09 from the transmission device 110, the relay device 120 deletes the buffer-set data d09 from the transfer buffer 121.

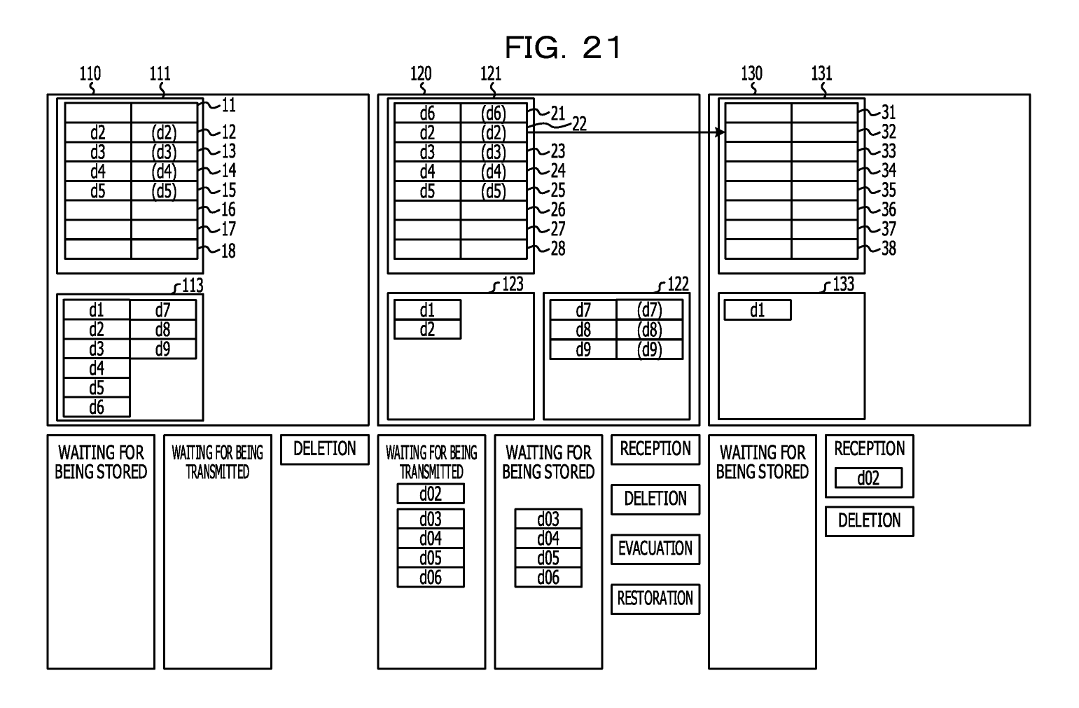

Now, it is assumed that restoring of the data d6 to the transfer buffer 121 by the relay device 120 is completed, and transmission of the data d2 by the relay device 120 is not completed. With these assumptions, the processing is described with reference to FIG. 21. As illustrated in FIG. 21, the relay device 120 stores, in the transmission queue, a transmission request for transmitting the restored buffer-set data d06 to the reception device 130. Also, the relay device 120 stores, in the storing queue, a storing request for storing the data d6 included in the restored buffer-set data d06 in the volume 123.

Hereinafter, the relay device 120 transmits, in the same way as with FIGS. 9 to 21, the buffer-set data d02 to d09 to the reception device 130. Also, in the event of restoring the data d07 to d09, the relay device 120 starts storing of the data d7 to d9 in the volume 123. Upon receiving the buffer-set data d02 to d09, the reception device 130 starts storing of the data d2 to d9 in the volume 133.

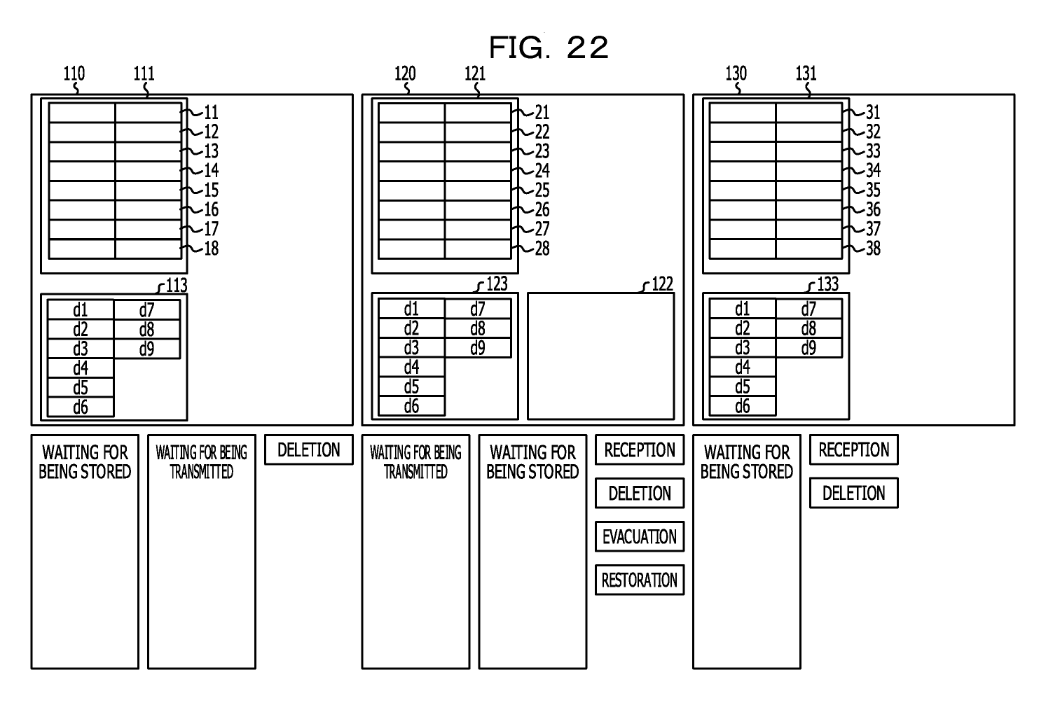

As a result, as illustrated in FIG. 22, the relay device 120 may perform mirroring of the data d1 to d9 stored in the volume 113 of the transmission device 110 to the volume 123 of the relay device 120. Also, the reception device 130 may perform mirroring of the data d1 to d9 stored in the volume 113 of the transmission device 110 to the volume 133 of the reception device 130.

Thus, the relay device 120 may receive buffer-set data from the transmission device 110 and transmit buffer-set data to the reception device 130 while securing a free region in the transfer buffer 121. Therefore, the transmission device 110 may continuously transmit buffer-set data without stopping transmission of the buffer-set data to the relay device 120.

Specifically, for example, in FIG. 19, since a free region is created by evacuating the buffer-set data d06, the relay device 120 may receive the buffer-set data d09. Also, the relay device 120 and reception device 130 may perform mirroring of data stored in the transmission device 110.

Here, a case has been described as an example wherein the usage amount of the transfer buffer 121 exceeds the threshold by transmission of buffer-set data to the reception device 130 being not completed, but a condition is not restricted to this. For example, there is a case where the usage amount of the transfer buffer 121 exceeds the threshold by storing of data included in buffer-set data in the volume 123 being not completed.

Here, the relay device 120 realizes start of transmission and start of storing by the queues, but realization is not restricted to this. For example, start of transmission and start of storing may be realized by pointers. Here, the relay device 120 transmits buffer-set data one at a time, but the transmission method is not restricted to this. For example, the relay device 120 may transmit buffer-set data by multiplexing transmission.

Data Input Processing by Transmission Device

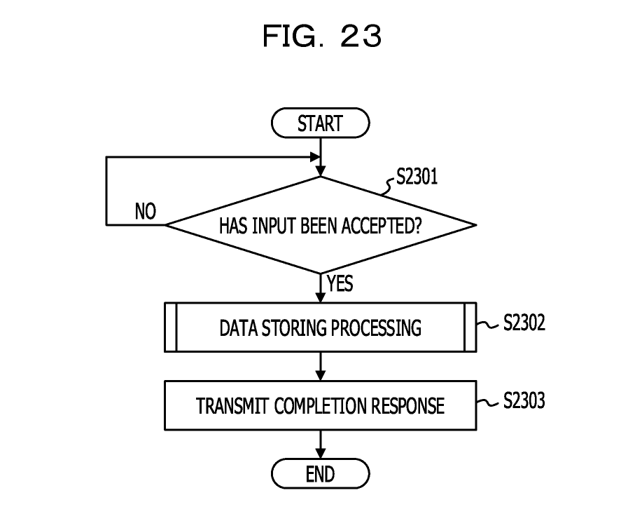

Next, a processing procedure of data input processing by the transmission device 110 will be described in detail with reference to FIG. 23. Here, it is assumed that a flag that indicates cascade connection is set in the device management information table. Also, it is assumed that copy session has been established. Data input processing is executed each time Write I/O instruction is accepted from the host device 230.

FIG. 23 is a flowchart illustrating the processing procedure of the data input processing by the transmission device 110. In FIG. 23, first, the transmission device 110 determines whether or not input of Write I/O instruction regarding data has been accepted from the host device 230 (S2301). In the event that input has not been accepted (No in S2301), the transmission device 110 returns to S2301, and waits for input of Write I/O instruction regarding data.

In the event that input has been accepted (Yes in S2301), the transmission device 110 starts execution of data storing processing for storing data in the transmission buffer 111 (S2302). Next, the transmission device 110 transmits a completion response of data storing to the host device 230 (S2303).

Here, the transmission device 110 may execute processing in S2303 before execution of the data storing processing in S2302 is completed. Thus, speed of response to the host device 230 may be increased. Thereafter, the transmission device 110 ends the data input processing. Thus, the transmission device 110 may execute preparation for data transmission to the relay device 120.

Data Storing Processing

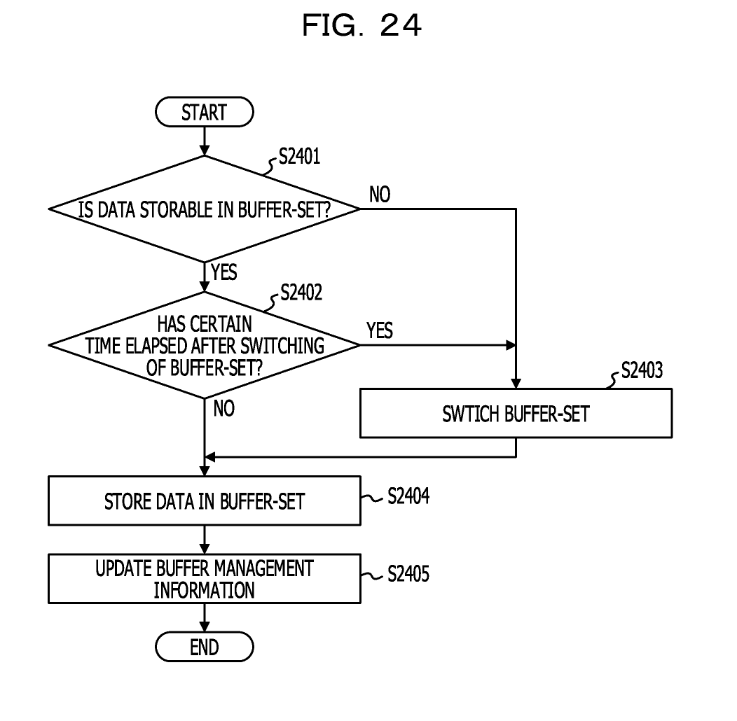

Next, a processing procedure of the data storing processing illustrated in S2302 will be described in detail with reference to FIG. 24.

FIG. 24 is a flowchart illustrating a detailed processing procedure of the data storing processing. In FIG. 24, the transmission device 110 determines whether or not data is storable in a buffer-set serving as a storing destination (S2401). The “storable” mentioned here is that there is a free region, in a buffer-set serving as a storing destination, for storing data for which Write I/O instruction has been accepted.

In the event that data is not storable (No in S2401), the transmission device 110 switches the buffer-set serving as a storing destination (S2403), and proceeds to S2404.

In the event that data is storable (Yes in S2401), the transmission device 110 determines whether or not a certain period of time has elapsed from the last buffer-set switching (S2402). In the event that a certain period of time has elapsed (Yes in S2402), the transmission device 110 switches the buffer-set serving as a storing destination (S2403), and proceeds to S2404.

In the event that a certain period of time has not elapsed (No in S2402), the transmission device 110 proceeds to S2404. Next, the transmission device 110 stores the data in the buffer-set serving as the storing destination (S2404).

The transmission device 110 updates BIT information (S2405). The transmission device 110 specifically stores a copy source LUN, a copy source LBA, a copy destination LUN, and a copy destination LBA regarding the data for which Write I/O instruction has been accepted in the buffer management information table, for example. Also, the transmission device 110 sets information that indicates an “unstored” state in the “status” item of the buffer management information table. Then, the transmission device 110 ends the data storing processing. Thus, the transmission device 110 may transmit the data stored in the buffer-set.

Data Transmission Processing by Transmission Device

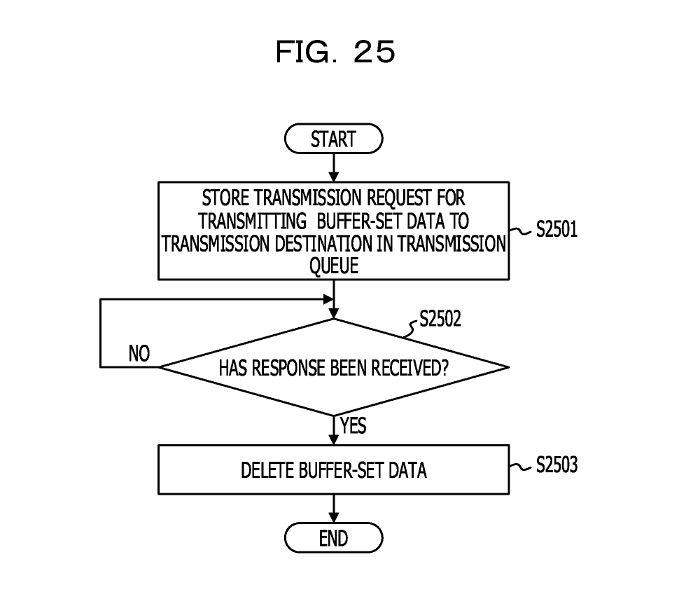

Next, a processing procedure of data transmission processing by the transmission device 110 will be described in detail with reference to FIG. 25. The data transmission processing is executed each time storing of data in a buffer-set by the data storing processing is completed.

FIG. 25 is a flowchart illustrating a detailed processing procedure of data transmission processing by the transmission device 110. In FIG. 25, first, the transmission device 110 stores a transmission request for transmitting buffer-set data to the relay device 120 in the transmission queue (S2501).

Next, the transmission device 110 determines whether or not a response that indicates storing and transmission of data are completed has been received (S2502). In the event of having received no response (No in S2502), the transmission device 110 returns to S2502, and waits for reception of the response.

In the event of having received the response (Yes in S2502), the transmission device 110 releases the transmission buffer 111 (S2503). The transmission device 110 specifically deletes the buffer-set data regarding which the response has been received, from the transmission buffer 111, for example.

Also, the transmission device 110 clears a bit corresponding to the buffer-set data regarding which transfer has been completed, from the copy state management bitmap. Then, the transmission device 110 ends the data transmission processing. Thus, the transmission device 110 may transmit the buffer-set data to the relay device 120.

Data Transmission Execution Processing

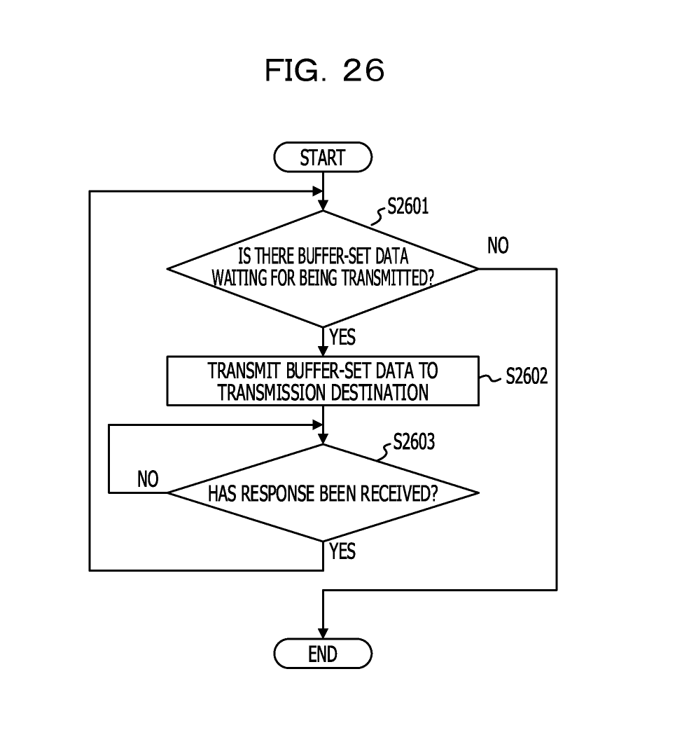

Next, a processing procedure of data transmission execution processing will be described in detail with reference to FIG. 26. The data transmission execution processing is executed for each certain period of time to perform data transmission with reference to the transmission queue, for example.

FIG. 26 is a flowchart illustrating a detailed processing procedure of data transmission execution processing. In FIG. 26, the transmission device 110 determines whether or not there is buffer-set data waiting for being transmitted, with reference to the transmission queue (S2601). In the event that there is no buffer-set data waiting for being transmitted (No in S2601), the transmission device 110 ends the data transmission execution processing.

In the event that there is buffer-set data waiting for being transmitted (Yes in S2601), the transmission device 110 dequeues a transmission request which is located in the top of the transmission queue, and transmits the buffer-set data corresponding to the dequeued transmission request to the transmission destination (S2602). The transmission device 110 specifically transmits the buffer control management information table and buffer management information table to the relay device 120 to cause the relay device 120 to secure a buffer-set for reception, for example. Next, the transmission device 110 collectively transmits buffer-set data corresponding to the transmission request stored in the buffer-set to the relay device 120.

The transmission device 110 may collectively transmit multiple buffer-set data by performing multiplexing transmission depending on a communication band without processing buffer-set data waiting for being transmitted one at a time.

Next, the transmission device 110 determines whether or not a response has been received (S2603). In the event of having received no response (No in S2603), the transmission device 110 returns to S2603, and waits for reception of a response. In the event of having received a response (Yes in S2603), the transmission device 110 returns to S2601. Thus, the transmission device 110 may transmit the buffer-set data to the relay device 120.

Data Transfer Processing by Relay Device

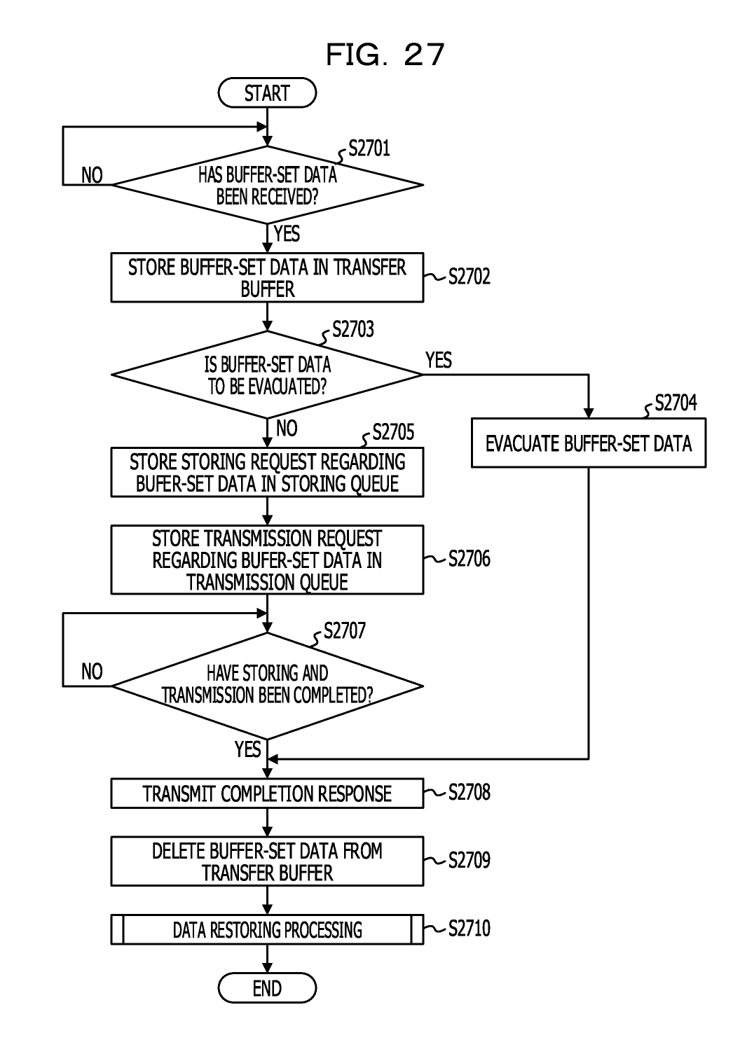

Next, a processing procedure of data transfer processing by the relay device 120 will be described in detail with reference to FIG. 27.

FIG. 27 is a flowchart illustrating a detailed processing procedure of data transfer processing by the relay device 120. In FIG. 27, first, the relay device 120 determines whether or not buffer-set data has been received (S2701). In the event of having received no buffer-set data (No in S2701), the relay device 120 returns to S2701, and waits for reception of buffer-set data.

In the event of having received buffer-set data (Yes in S2701), the relay device 120 executes storing of the buffer-set data in the transfer buffer 121 (S2702). Next, the relay device 120 determines whether to evacuate the buffer-set data stored in the transfer buffer 121 (S2703). The relay device 120 specifically determines, for example, in the event that the usage amount of the transfer buffer 121 is equal to or greater than a threshold, or in the event that buffer-set data remains in the evacuation disk 122, to evacuate the buffer-set data.

In the event of evacuating the buffer-set data (Yes in S2703), the relay device 120 evacuates the buffer-set data stored in the transfer buffer 121 to the evacuation disk 122, deletes the buffer-set data from the transfer buffer 121 (S2704), and proceeds to S2708.

In the event of not evacuating the buffer-set data (No in S2703), the relay device 120 stores, in the storing queue, a storing request for storing data included in the buffer-set data stored in the transfer buffer 121 in the volume 123 (S2705). Next, the relay device 120 stores, in the transmission queue, a transmission request for transmitting the buffer-set data stored in the transfer buffer 121 to the reception device 130 (S2706).

Next, the relay device 120 determines whether or not storing and transmission regarding the buffer-set data have been completed (S2707). In the event that storing and transmission regarding the buffer-set data have not been completed (No in S2707), the relay device 120 returns to S2707, and waits for completion.

In the event that storing and transmission of the data have been completed (Yes in S2707), the relay device 120 transmits a completion response to the transmission device 110 (S2708). Upon receiving a response from the transmission device 110, the relay device 120 deletes, from the transfer buffer 121, the buffer-set data regarding which storing and transmission have been completed (S2709). The relay device 120 specifically clears a bit corresponding to the buffer-set data to be deleted, from the copy state management bitmap, for example.

Next, the relay device 120 executes data restoring processing (S2710). Thus, the relay device 120 may transmit buffer-set data to the reception device 130 while securing a free region in the transfer buffer 121.

Also, the relay device 120 executes data transmission execution processing. The data transmission execution processing to be executed by the relay device 120 is the same processing as the data transmission execution processing to be executed by the transmission device 110 illustrated in FIG. 26, and accordingly, description thereof will be omitted here. Thus, the relay device 120 may transmit buffer-set data to the reception device 130.

Data Storing Execution Processing

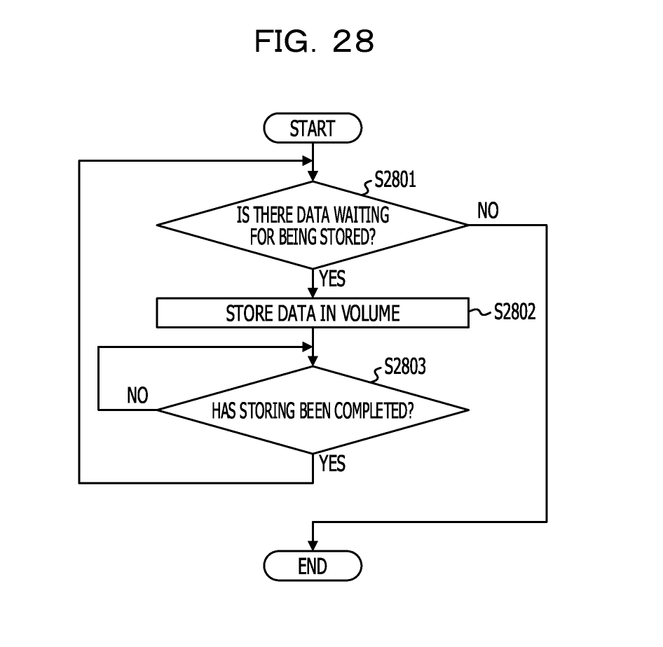

Next, a processing procedure of data storing execution processing will be described in detail with reference to FIG. 28.

FIG. 28 is a flowchart illustrating a detailed processing procedure of data storing execution processing. In FIG. 28, the relay device 120 determines whether or not there is data waiting for being stored, with reference to the storing queue (S2801). In the event that there is no data waiting for being stored (No in S2801), the relay device 120 ends the data storing execution processing.

In the event that there is data waiting for being stored (Yes in S2801), the relay device 120 dequeues a storing request which is located in the top of the storing queue, and stores data corresponding to the dequeued storing request, in the volume 123 (S2802).

Next, the relay device 120 determines whether or not storing has been completed (S2803). In the event that storing has not been completed (No in S2803), the relay device 120 returns to S2803, and waits for completion of storing. In the event that storing has been completed (Yes in S2803), the relay device 120 returns to S2801. Thus, the relay device 120 may perform mirroring of data stored in the transmission device 110 to the volume 123.

Data Restoring Processing

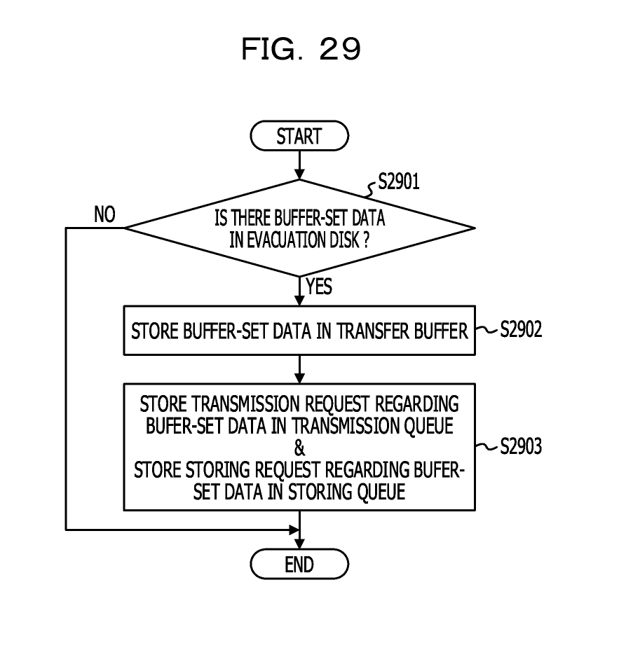

Next, a processing procedure of data restoring processing will be described in detail with reference to FIG. 29.

FIG. 29 is a flowchart illustrating a detailed processing procedure of data restoring processing. In FIG. 29, the relay device 120 determines whether or not there is buffer-set data in the evacuation disk 122 (S2901). In the event that there is no buffer-set data (No in S2901), the relay device 120 ends the data restoring processing.

In the event that there is buffer-set data (Yes in S2901), the relay device 120 stores, in a buffer-set of the transfer buffer 121, the top buffer-set data among the buffer-set data stored in the evacuation disk 122 (S2902).

Next, the relay device 120 stores, in the transmission queue, a transmission request regarding the buffer-set data stored in the transfer buffer 121, and stores, in the storing queue, a storing request regarding the buffer-set data stored in the transfer buffer 121 (S2903). The relay device 120 then ends the data restoring processing. Thus, the relay device 120 may restore the buffer-set data to transmit the restored buffer-set data.

Data Reception Processing by Reception Device

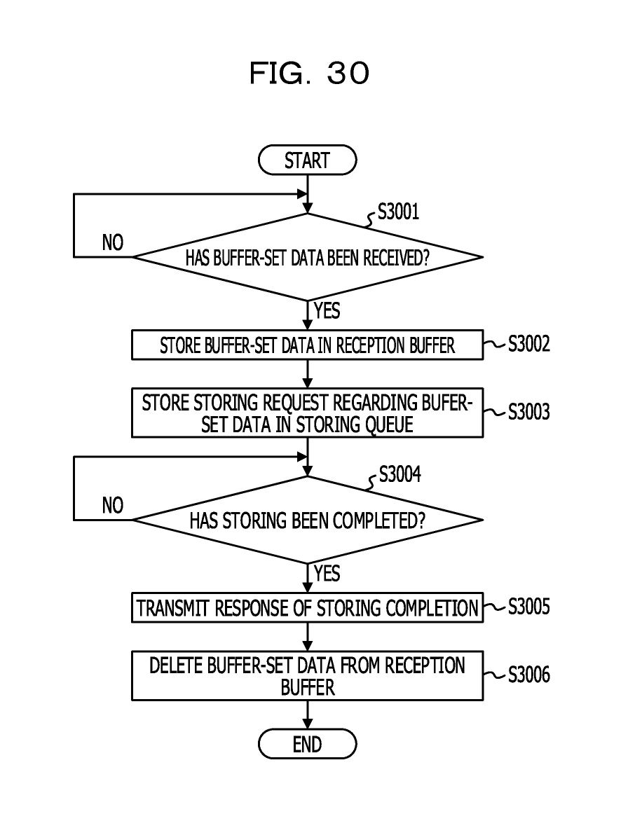

Next, a processing procedure of data reception processing by the reception device 130 will be described in detail with reference to FIG. 30.

FIG. 30 is a flowchart illustrating a detailed processing procedure of data reception processing by the reception device 130. In FIG. 30, first, the reception device 130 determines whether or not buffer-set data has been received (S3001). In the event that no buffer-set data has been received (No in S3001), the reception device 130 returns to S3001, and waits for reception of buffer-set data.

In the event that buffer-set data has been received (Yes in S3001), the reception device 130 executes storing of the received buffer-set data in the reception buffer 131 (S3002). Next, the reception device 130 stores, in the storing queue, a storing request for storing data included in the buffer-set data stored in the reception buffer 131 in the volume 133 (S3003).

Next, the reception device 130 determines whether or not storing has been completed (S3004). In the event that storing has not been completed (No in S3004), the reception device 130 returns to S3004, and waits for completion of storing.

In the event that storing has been ended (Yes in S3004), the reception device 130 transmits a response of storing completion to the relay device 120 (S3005). Upon receiving a response from the relay device 120, the reception device 130 deletes the buffer-set data regarding which storing has been completed from the reception buffer 131 (S3006). The reception device 130 then ends the data reception processing. Thus, the reception device 130 may receive the buffer-set data from the relay device 120.

Also, the reception device 130 executes data storing execution processing. The data storing execution processing to be executed by the reception device 130 is the same processing as the data storing execution processing to be executed by the relay device 120 illustrated in FIG. 28, and accordingly, description thereof will be omitted here. Thus, the reception device 130 may perform mirroring of data stored in the transmission device 110 to the volume 133.

As described above, the relay device 120 evacuates, so as to guarantee the storing order, the buffer-set data stored in the transfer buffer 121 to the evacuation disk 122, and restores the buffer-set data stored in the evacuation disk 122 to the transfer buffer 121.

Thus, the relay device 120 may realize data transfer with the storing order being guaranteed, and also secure a free region in the transfer buffer 121. As a result, the transmission device 110 may not stop data transmission to the relay device 120 regardless of the transfer state of the relay device 120. Accordingly, reception delay of data at the relay device 120 is suppressed. Also, a free region of the transfer buffer 121 may be secured without increasing the size of the transfer buffer 121 of the relay device 120, and the physical size of memory to realize the transfer buffer 121 of the relay device 120 may not be increased, and accordingly, increase in memory manufacturing cost and running cost may be suppressed.

The relay device 120 stores data included in the buffer-set data stored in the transfer buffer 121 in the volume 123 within the relay device 120. Thus, the relay device 120 may perform mirroring of data stored in the transmission device 110. As a result, in the event that data has erroneously been deleted at the transmission device 110, or the like, the transmission device 110 may restore the data stored in the transmission device 110 using the data stored in the relay device 120.

The relay device 120 transmits a completion notification that indicates that transmission of buffer-set data to the reception device 130, and storing of data in the volume 123 have been completed, to the transmission device 110. Thus, the transmission device 110 may create a free region by deleting buffer-set data stored in the transmission buffer 111 corresponding to the completion notification.

The relay device 120 transmits a completion notification that indicates that evacuation to the evacuation disk 122 has been completed, to the transmission device 110. Thus, the transmission device 110 may create a free region by deleting buffer-set data stored in the transmission buffer 111.

Note that the relay method described in the present embodiment may be realized by executing a program prepared beforehand at a computer such as a personal computer, workstation, or the like. The present relay program is recorded in a computer-readable recording medium such as a hard disk, flexible disk, compact disc read-only memory (CD-ROM), magnetooptic disc (MO), Digital Versatile Disc (DVD), or the like. The relay program is read out from the recording medium and executed by a computer. Also, the present relay program may be distributed via a network such as the Internet or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A relay device for transmitting a data group received from a transmission source to a transmission destination, the relay device comprising:
a first storage unit including a first storage region and a second storage region;
a second storage unit; and
a processor to
receive part data of the data group from the transmission source,
store the received part data in the first storage region in accordance with storing order when there is a free region in the first storage region,
store the received part data in the second storage region when there is no free region in the first storage region,
evacuate the part data stored in the second storage region to the second storage unit in accordance with the storing order,
delete the evacuated part data from the second storage region,
transmit the part data stored in the first storage region to the transmission destination,
delete the transmitted part data from the first storage region to generate a free region in the first storage region,
determine whether any part data remains in the second storage unit,
determine whether a free region has been generated in the first storage region,
restore, when it is determined that some part data remains in the second storage unit and that a free region has been generated in the first storage region, the remaining part data to the generated free region in accordance with the storing order, and
delete the restored part data from the second storage unit.

2. The relay device according to claim 1, wherein
the processor stores part data subsequently received from the transmission source in the second storage region when it is determined that some part data remains in the second storage unit.

3. The relay device according to claim 1, further comprising:
a third storage unit,
wherein
the processor stores, in the third storage unit, first part data stored in the first storage region in accordance with the storing order.

4. The relay device according to claim 3, wherein
the processor transmits, when the first part data has been transmitted and stored in the third storage unit, information that indicates processing completion of the first part data to the transmission source.

5. The relay device according to claim 1, wherein
the processor transmits, when the evacuated data has been deleted from the second storage region, information that indicates deletion completion of the evacuated data to the transmission source.

6. A relay method executed by a relay device for transmitting a data group received from a transmission source to a transmission destination, the method comprising:
receiving, by the relay device, part data of the data group from the transmission source;
storing the received part data in a first storage region in accordance with storing order when there is a free region in the first storage region, the first storage region being included in a first storage unit;
storing the received part data in a second storage region when there is no free region in the first storage region, the second storage region being included in the first storage unit;
evacuating the part data stored in the second storage region to a second storage unit in accordance with the storing order;
deleting the evacuated part data from the second storage region;
transmitting the part data stored in the first storage region to the transmission destination;
deleting the transmitted part data from the first storage region to generate a free region in the first storage region;
determining whether any part data remains in the second storage unit;
determining whether a free region has been generated in the first storage region;
restoring, when it is determined that some part data remains in the second storage unit and that a free region has been generated in the first storage region, the remaining part data to the generated free region in accordance with the storing order; and
deleting the restored part data from the second storage unit.

7. A computer-readable recording medium storing a program that causes a computer to execute a procedure, the procedure comprising:
receiving part data of a data group from a transmission source;
storing the received part data in a first storage region in accordance with storing order when there is a free region in the first storage region, the first storage region being included in a first storage unit;
storing the received part data in a second storage region when there is no free region in the first storage region, the second storage region being included in the first storage unit;
evacuating the part data stored in the second storage region to a second storage unit in accordance with the storing order;
deleting the evacuated part data from the second storage region;
transmitting the part data stored in the first storage region to a transmission destination;
deleting the transmitted part data from the first storage region to generate a free region in the first storage region;
determining whether any part data remains in the second storage unit;
determining whether a free region has been generated in the first storage region;
restoring, when it is determined that some part data remains in the second storage unit and that a free region has been generated in the first storage region, the remaining part data to the generated free region in accordance with the storing order; and
deleting the restored part data from the second storage unit.
